(19) United States
(12) Patent Application Publication
(10) Pub. No.: US 2014/0337792 A1
(43) Pub. Date: Nov. 13, 2014

(54) DISPLAY APPARATUS AND USER INTERFACE SCREEN PROVIDING METHOD THEREOF

(71) Applicant: SAMSUNG ELECTRONICS CO., LTD., Suwon-si (KR)

(72) Inventors: Joon-ho PHANG, Seoul (KR); Joo-sun MOON, Seoul (KR); Christopher E. BANGLE, Clavesana CN (IT)

(73) Assignee: SAMSUNG ELECTRONICS CO., LTD., Suwon-si (KR)

(21) Appl. No.: 14/275,134

(22) Filed: May 12, 2014

(30) Foreign Application Priority Data
May 10, 2013 (KR) 10-2013-0053445

(51) Int. Cl. G06F 3/0481; G06F 3/0485

(52) U.S. Cl. CPC G06F 3/04815; G06F 3/0485
USPC 715/784; 715/850

(57) ABSTRACT

A display apparatus and a method of providing a user interface screen on a display apparatus are provided. The display apparatus includes: a display configured to display a polyhedral graphic user interface (GUI) on a screen; a user interface unit configured to receive a user interaction with the displayed polyhedral GUI; and a controller configured to control the display to display at least one of detailed information and associated information of content information on at least one surface of the displayed polyhedral GUI according to the received user interaction.

### CROSS-REFERENCE TO RELATED APPLICATION

This application claims priority from Korean Patent Application No. 10-2013-0053445, filed on May 10, 2013 in the Korean Intellectual Property Office, the disclosure of which is incorporated herein by reference in its entirety.

### BACKGROUND

1. Field

Apparatuses and methods consistent with exemplary embodiments relate to a display apparatus and a user interface (UI) screen providing method thereof, and more particularly, to a display apparatus which displays a polyhedral graphic user interface (GUI), and a UI screen providing method thereof.

2. Description of the Related Art

With the development of electronic technology, various types of display apparatuses have been developed. In particular, display apparatuses such as televisions (TVs), personal computers (PCs), tablet PCs, portable phones, and MPEG audio layer-3 (MP3) players have been distributed so widely that they are now used in most homes.

In recent years, to meet needs of users who want newer and various functions, attempts to develop new types of display apparatuses have been made. For example, various types of interfaces configured to control the display apparatuses have been suggested.

In this regard, there is a need for a method of providing an interface screen that intuitively provides a variety of information and has convenient user operability.

### SUMMARY

Aspects of exemplary embodiments overcome the above disadvantages and other disadvantages not described above. Also, an exemplary embodiment is not required to overcome the disadvantages described above, and an exemplary embodiment may not overcome any of the problems described above.

Aspects of exemplary embodiments provide a display apparatus which provides various types of information to one surface of a polyhedral GUI according to a user interaction with the polyhedral GUI, and a UI screen providing method thereof.

According to an aspect of an exemplary embodiment, there is provided a display apparatus including: a display configured to display a polyhedral graphic user interface (GUI) on a screen; a user interface unit configured to receive a user interaction with the displayed polyhedral GUI; and a controller configured to control the display to display at least one of detailed information of content and associated information of content on at least one surface of the polyhedral GUI according to the user interaction.

The user interaction may be at least one of an interaction for rotating the polyhedral GUI, a rubbing interaction with the polyhedral GUI, and a scroll interaction with the polyhedral GUI.

The controller may control to display the at least one of the detailed information of content and the associated information of the content by simultaneously rotating other polyhedral GUIs related to the polyhedral GUI with the polyhedral GUI according to the interaction for rotating the polyhedral GUI.

The interaction for rotating the polyhedral GUI may include at least one of an interaction for rotating a single polyhedral GUI, and an interaction for rotating a group polyhedral GUI.

The controller may control to display the at least one of the detailed information of content and the associated information of content which have different levels according to at least one of a rubbing strength and a rubbing time of the rubbing interaction with a surface of the polyhedral GUI.

The controller may control to display the content information provided by a content provider when another surface of the polyhedral GUI is displayed according to the interaction for rotating the polyhedral GUI in a state in which information for the content provider is displayed on the surface of the polyhedral GUI.

The polyhedral GUI may be displayed in a floating form in a three-dimensional (3D) space formed by three walls along an X-axis of the screen, and the user interaction may include a peeping interaction with the 3D space.

The controller may control to display the detailed information of the content information on a plurality of panel GUIs having a form in which the polyhedral GUI is sliced according to the user interaction.

The controller may control to display corresponding advertisement information on at least some of all polyhedral GUIs displayed on the screen according to a user interaction for selecting the advertisement information in a state in which the advertisement information is displayed on the surface of the polygonal GUI.

When the advertisement information displayed on the surface of the polyhedral GUI is a preset image, the controller may control to display the preset image on the at least some of the polyhedral GUIs separately or to magnify the preset image to one image and display the one image on the at least some of the polyhedral GUIs.

The controller may control to provide different types of information with respect to the same interaction type according to a type of content represented by the polyhedral GUI.

According to an aspect of another exemplary embodiment, there is provided a method of providing a user interface (UI) screen on a display apparatus, the method including: displaying a polyhedral graphic user interface (GUI) on a screen; receiving a user interaction with the polyhedral GUI; and displaying at least one of detailed information of content and associated information of content information on at least one surface of the polyhedral GUI according to the user interaction.

The user interaction may be at least one of an interaction for rotating the polyhedral GUI, a rubbing interaction with the polyhedral GUI, and a scroll interaction with the polyhedral GUI.

The displaying the at least one of the detailed information of content and the associated information of content may include displaying the at least one of the detailed information of content and the associated information of content by simultaneously rotating other polyhedral GUIs related to the polyhedral GUI with the polyhedral GUI according to the rotating interaction of the polyhedral GUI.

The interaction for rotating the polyhedral GUI may include at least one of an interaction for rotating a single polyhedral GUI, and an interaction for rotating a group polyhedral GUI.

The displaying the at least one of the detailed information of content and the associated information of content may include displaying the at least one of the detailed information content and the associated information of content which have different levels according to at least one of a rubbing strength and a rubbing time of the rubbing interaction with a surface of the polyhedral GUI.

The polyhedral GUI may be displayed in a floating form in a 3D space formed by three walls along an X-axis of the screen.

The user interaction may include a peeping interaction with the 3D space.

The displaying the at least one of the detailed information of content and the associated information of content may include displaying the detailed information of content on a plurality of panel GUIs in a form in which the polyhedral GUI is sliced according to the user interaction.

The method may further include displaying corresponding advertisement information on at least some of all polyhedral GUIs displayed on the screen according to a user interaction for selecting the advertisement information in a state in which the advertisement information is displayed on the surface of the polyhedral GUI.

The displaying the advertisement information may include, when the advertisement information displayed on the surface of the polyhedral GUI is a preset image, displaying the preset image on the at least some of the polyhedral GUIs separately or magnifying the preset image to one image and displaying the one image on the at least some of the polyhedral GUIs.

According to an aspect of another exemplary embodiment, there is provided an image processing apparatus including: a user interface unit configured to receive a user interaction with a displayed polyhedral GUI; and a controller configured to, in response to the received user interaction being an interaction for rotating the displayed polyhedral GUI, output for display different information according to a type of the received user interaction with the displayed polyhedral GUI.

According to aspects of the above-described various exemplary embodiments, a variety of information can be provided on an optimized screen according to a user interaction to improve convenience of the user.

Additional and/or other aspects and advantages will be set forth in part in the description which follows and, in part, will be obvious from the description, or may be understood by practice of exemplary embodiments.

### BRIEF DESCRIPTION OF THE DRAWINGS

The above and/or other aspects will be more apparent by describing certain exemplary embodiments with reference to the accompanying drawings, in which:

FIG. 1 is a view explaining a display system according to an exemplary embodiment;

FIGS. 2A and 2B are block diagrams illustrating configurations of display apparatuses according to one or more exemplary embodiments;

FIG. 3 is a view explaining various software modules stored in a storage unit according to an exemplary embodiment;

FIGS. 4A and 4B, 5A and 5B, 6A and 6B, 7A and 7B, 8A and 8B, 9A to 9C, 10A and 10B, 11A to 11F, 12A to 12C, 13, 14A to 14C, 15A and 15B, and 16A and 16B are views illustrating UI screens according to various exemplary embodiments;

FIG. 17 is a view explaining a UI screen providing method according to an exemplary embodiment;

FIG. 18 is a view explaining a UI screen providing method according to another exemplary embodiment; and

FIG. 19 is a view explaining a UI screen providing method according to another exemplary embodiment.

### DETAILED DESCRIPTION OF EXEMPLARY EMBODIMENTS

Certain exemplary embodiments will now be described in greater detail with reference to the accompanying drawings.

In the following description, the same reference numerals are used for the same elements even in different drawings. The matters defined in the description, such as detailed construction and elements, are provided to assist in a comprehensive understanding of exemplary embodiments. Thus, it is apparent that exemplary embodiments can be carried out without those specifically defined matters. Also, well-known functions or constructions are not described in detail since they would obscure exemplary embodiments with unnecessary detail. Furthermore, it is understood that, hereinafter, expressions such as “at least one of,” when preceding a list of elements, modify the entire list of elements and do not modify the individual elements of the list.

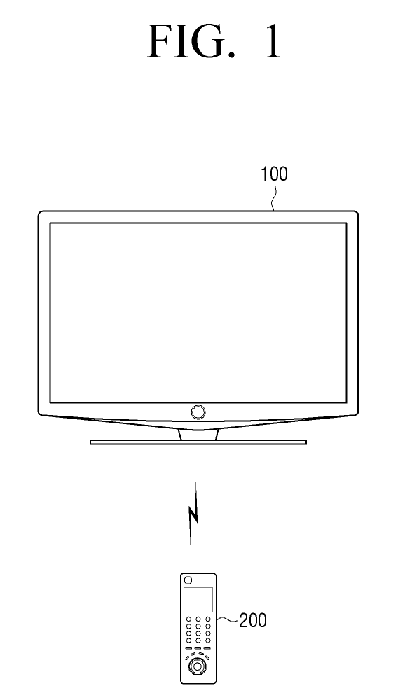

FIG. 1 is view explaining a display system according to an exemplary embodiment.

Referring to FIG. 1, the display system according to an exemplary embodiment includes a display apparatus 100 and a remote control apparatus 200.

The display apparatus 100 may be implemented as a digital television (TV) as illustrated in FIG. 1, although it is understood that the display apparatus 100 is not limited thereto in other exemplary embodiments. For example, the display apparatus may be implemented as various types of apparatuses having a display operation, such as a personal computer (PC), a portable phone, a tablet PC, a portable multimedia player (PMP), a personal digital assistant (PDA), a navigation system, a camera, a remote controller, etc. When the display apparatus 100 is implemented as a portable apparatus, the display apparatus 100 may be implemented with a touch screen embedded therein to execute a program using a finger or a pen (for example, a stylus pen). Hereinafter, for convenience of description, it is assumed that the display apparatus 100 is, exemplarily, implemented as the digital TV.

When the display apparatus 100 is implemented as the digital TV, the display apparatus 100 may be controlled by a user motion or the remote control apparatus 200. At this time, the remote control apparatus 200 is an apparatus configured to remotely control the display apparatus 100, and may receive a user command and transmit a control signal corresponding to the input user command to the display apparatus 100. The remote control apparatus 200 may be implemented in various types, for example, to sense a motion of the remote control apparatus 200 and transmit a signal corresponding to the motion, to recognize a voice and transmit a signal corresponding to the recognized voice, to transmit a signal corresponding to an input key, etc. At this time, the remote control apparatus 200 may be implemented to include a motion sensor, a touch sensor, an optical joystick (OJ) sensor applying optical technology, a physical button (for example, a tact switch), a display screen, a microphone, and the like configured to receive various types of user commands. Here, the OJ sensor is an image sensor configured to sense a user operation through an OJ, and may operate like an upside-down optical mouse. That is, the user can merely graze the OJ with a finger for the OJ to analyze a signal.

The display apparatus 100 may provide various UI screens according to the user command input through the remote control apparatus 200. Further, the display apparatus 100 may provide various operations and information according to various types of user interactions to the UI screen.

In particular, the display apparatus 100 may provide a UI screen including a polyhedral GUI element, and provide various types of information according to various types of user interactions with the polyhedral GUI element. Hereinafter, various exemplary embodiments will be described with reference to block diagrams illustrating specific configurations of the display apparatus 100.

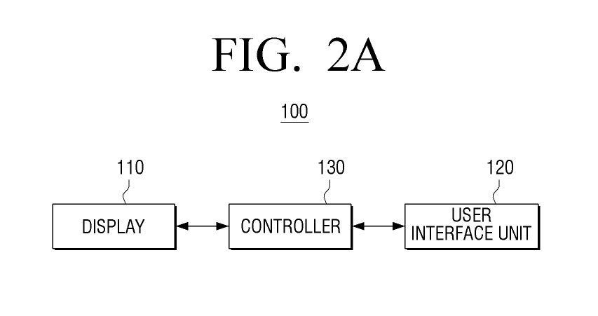

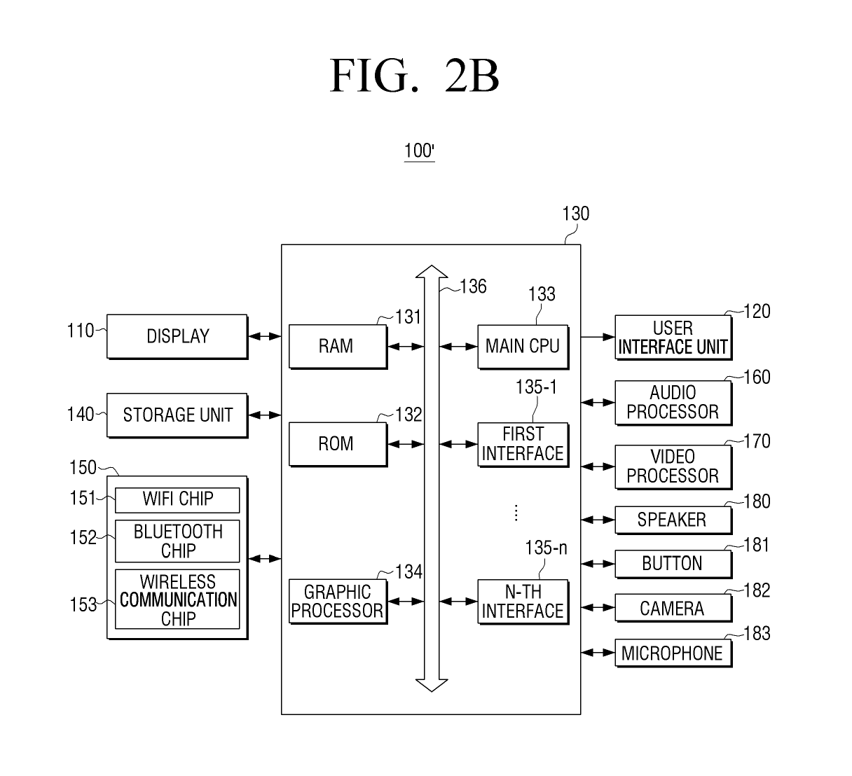

FIGS. 2A and 2B are block diagrams illustrating configurations of a display apparatus 100 according to one or more exemplary embodiments.

Referring to FIG. 2A, the display apparatus 100 includes a display 110, a user interface unit 120, and a controller 130.

The display 110 displays a screen. Here, the screen may include a reproduction screen of a variety of content such as an image, a moving image, text, music, an application execution screen including a variety of content, a web browser screen, a GUI screen, etc.

Here, the display 110 may be implemented as a liquid crystal display (LCD), an organic light emitting diode (OLED), and the like, but the display 110 is not limited thereto. In some cases, the display 110 may be implemented as a flexible display, a transparent display, and the like.

The display 110 may display a polyhedral GUI, according to an exemplary embodiment, based on a preset event. Here, the polyhedron may be a cube, and at this time, the polyhedral GUI may be referred to as a cubic GUI. However, the polyhedron is not limited to a cubic shape. The polyhedron may be implemented in various shapes, such as a triangular prism, a hexagonal prism, a rectangular parallelepiped, etc. Hereinafter, it is assumed and described that the polyhedral GUI is, exemplarily, the cubic GUI, for convenience of description.

<Shape of and Information Provided by Cubic GUI>

The cubic GUI is a hexahedral display element, and the cubic GUI may be implemented to represent a predetermined object. For example, the cubic GUI may represent various objects, such as content, a content provider, a service provider, etc.

At least one surface of the cubic GUI may operate as an information surface configured to provide predetermined information to a user. The at least one surface of the cubic GUI may provide a variety of information according to the object represented by the cubic GUI. For example, the at least one surface of the cubic GUI may display a variety of information, such as content provider information, content information, service provider information, service information, application execution information, content execution information, user information depending on a menu depth according to a user command, etc. Further, the displayed information may include various elements, such as text, a file, an image, a moving image, an icon, a button, a menu, and a three-dimensional (3D) icon. For example, the content provider information may be provided in a type of an icon, a logo, or the like which symbolizes a corresponding content provider, and the content information may be provided in a thumbnail form. The user information may be provided in a profile image of each user. The thumbnail may be provided by decoding additional information provided in original content, and converting the decoded additional information into a thumbnail size, or by decoding the original content, converting the decoded original content into the thumbnail size, and extracting a reduced thumbnail image when there is no additional information. Here, the original content may have a still image form or a moving image form. When the original content is a moving image, a thumbnail image may be generated in the form of an animated image configured of a plurality of still images, in the form of a plurality of still image frames representing the moving image, a single still image frame representing the moving image, etc.

Although a variety of information may be pre-mapped to a cubic GUI, new information may be mapped to the cubic GUI in real time. For example, information for different content providers and content information provided by the content providers may be pre-mapped to cubic GUIs. In some cases, in a state in which the cubic GUIs represent the information for the different content providers, content information provided by one content provider is newly mapped to each cubic GUI and displayed according to a specific user interaction.

In some cases, the at least one surface of the cubic GUI may be implemented to perform a predetermined operation. For example, when a specific surface of the cubic GUI is displayed, an operation such as screen mode conversion is directly performed.

Further, the cubic GUI may be rotated, combined, or divided in various forms according to a user interaction type, which will be described in detail below.

<Display Space of Cubic GUI>

The display 110 may display a UI screen in a form in which a cubic GUI is floating in a 3D space.

Specifically, the display 110 may display the UI screen in a form in which cubic GUIs are floating at different X-Y coordinates in the 3D space formed by three walls arranged along an x-axis on the screen and having a preset depth along a Z-axis. That is, the display 110 may display the UI screen in a form in which a plurality of cubic GUIs are floating at the different X-Y coordinates to expose front surfaces thereof in the 3D space, which is a room-shaped space in which a first wall of the three walls forms a right surface, a second wall forms a rear surface, and a third wall forms a left surface.

The 3D space including the cubic GUI may be implemented such that a plurality of cubic GUIs are provided, and a new 3D space is displayed according to rotation. Specifically, an aisle area (i.e., connecting area or center area) disposed in a center, and regular hexahedral 3D spaces disposed to be connected to each other through the aisle area and to be spaced in a form of surrounding the aisle area may be provided. That is, an overall shape of the cubic rooms may be implemented to have a star-like structure. The 3D spaces may represent different categories, and an object included in each of the categories may be displayed through a cubic GUI. Here, the categories may be divided into various types, for example, a real time TV watching category, a video on demand (VOD) content-based category, a social networking service (SNS) content sharing-based category, an application providing category, a personal content category, and the like. The aforementioned division or selection of the categories is merely exemplary, and the categories may be provided in various manners in one or more other exemplary embodiments.

<Display Arrangement Type of Cubic GUI>

The display 110 may display a plurality of cubic GUIs to have a constant distance, and to be arranged in an n*m matrix form. However, the above-described arrangement of the plurality of cubic GUIs is merely exemplary, and the plurality of cubic GUIs may have various types of arrangements such as a radial arrangement, a linear arrangement, etc.

<Method of Providing Cubic GUI>

The display 110 may provide cubic GUIs in a two-dimensional (2D) or 3D manner. Here, the 2D method may be a display method for displaying the cubic GUIs in a form in which only one surface of each of the cubic GUIs is displayed and other surfaces thereof are hidden. The 3D method may be a method for displaying the cubic GUIs in a 3D form in which at least two surfaces of each of the cubic GUIs are displayed.

<Method of Providing UI Screen>

The display 110 may provide a UI screen including cubic GUIs in a 2D screen type or a 3D screen type. That is, the display 110 may implement a 3D screen by time-dividing a left-eye image and a right-eye image, and alternately displaying the time-divided left-eye image and right-eye image. Therefore, the user may obtain depth information of a 3D object such as the cubic GUI, and feel a cubic effect.

<Other Embodiments of Cubic GUI>

The display 110 may provide an openable and closable cubic GUI. For example, the cubic GUI may be configured to allow at least one surface of the cubic GUI to be opened and closed, and provide different information according to at least one of an opening and closing speed and an opening and closing manner of the opening and closing surface. Further, both sides of the opening and closing surface may be used as information surfaces after the opening and closing surface is opened.

Moreover, the display 110 may provide a dividable or combinable cubic GUI. Specifically, one cubic GUI may be divided to provide a plurality of different pieces of information, or a plurality of cubic GUIs may be combined to represent one piece of new information. For example, when a cubic GUI representing a content provider is divided into a plurality of sub cubic GUIs, the sub cubic GUIs may represent different content information provided from the content provider.

<Provision of Plurality of Screens>

The display 110 may provide a screen in which a plurality of screens are displayed. For example, when a plurality of pieces of content mapped to the plurality of cubic GUIs or a plurality of pieces of content mapped to one cubic GUI are selected, the plurality of pieces of selected content may be displayed on the plurality of screens. At this time, in the former case, the plurality of pieces of content may be selected through selection of the plurality of cubic GUIs, and in the latter case, the plurality of pieces of content may be selected through selection of the one cubic GUI. In some cases, other related cubic GUIs may be automatically selected through the selection of the one cubic GUI, and reproduced on the plurality of screens.

The plurality of screens may be displayed in a form including a main screen disposed in a central region of the screen, and first and second sub screens disposed on the left and right of the main screen.

The user interface unit 120 may receive various user interactions. Here, the user interface unit 120 may be implemented in various types according to an implementation example of the display apparatus 100. When the display apparatus 100 is implemented with a digital TV, the user interface unit 120 may be implemented with a remote controller receiver configured to receive a remote controller signal from the remote control apparatus 200, a camera configured to sense a motion of the user, a microphone configured to receive a voice of the user, and the like. The remote controller receive may be implemented with at least one of an infrared receiver, a Bluetooth receiver, a wireless network receiver, etc. Further, when the display apparatus 100 is implemented with a touch-based portable terminal, the user interface unit 120 may be implemented in a touch screen form forming a mutual layer structure with a touch pad. At this time, the user interface unit 120 may be used as or incorporated in the above-described display 110.

<User Interaction with Cubic GUI>

The user interface unit 120 may receive various user interactions with a cubic GUI.

The user interaction with a cubic GUI may include a user interaction with a cubic GUI itself and a user interaction with one surface of a cubic GUI according to an interaction type.

Specifically, the user interaction with a cubic GUI itself may include a user interaction for selecting a cubic GUI, a user interaction for rotating a cubic GUI, a user interaction for changing a display angle of a cubic GUI, a user interaction for slicing a cubic GUI, a user interaction for dividing/combining a cubic GUI, a user interaction for changing a size, a location, and a depth of a cubic GUI, and the like. For example, when an interaction for rotating the remote control apparatus 200 is input in a state in which a specific cubic GUI is selected by a point GUI, that is, in a pointing state, the selected cubic GUI is rotated and displayed. Further, when head rotation or head movement of the user is sensed in a state in which a cubic room including a plurality of cubic GUIs is displayed, display angles of the cubic room itself and cubic GUIs included in the cubic room are changed to be displayed. For example, when the user watches a screen in the left region on the basis of a front of the screen, that is, when a peeping interaction is input, a front surface of the cubic GUI as well as the cubic room may be rotated in a left direction to be displayed.

The user interaction with one surface of a cubic GUI may have various types, such as a user interaction for scrolling one surface of a cubic GUI, or a user interaction for rubbing one surface of a cubic GUI. For example, when a scrolling or rubbing operation for one corresponding surface of a cubic GUI is made in a state in which specific content information is displayed on the one surface of the cubic GUI, detailed information of content may be displayed on the one surface. At this time, the scrolling and rubbing operations may be made in various forms. For example, in a state in which a specific surface of a cubic GUI is pointed to, the rubbing or scrolling operation is made with respect to the specific surface through a motion of the remote control apparatus 200 or a motion of the user, or the scrolling and rubbing operations may be performed on a specific location (for example, a touch panel or an OJ sensor) or a specific button of the remote control apparatus 200.

When the rubbing operation is performed on a specific surface of a cubic GUI, detailed information may appear while a portion on which the rubbing operation is performed is removed (for example, like when a foggy mirror is rubbed).

When the scrolling operation is performed on a specific surface of a cubic GUI, detailed information may be displayed in a scrolling-up form according to a scroll direction.

The user interaction with a cubic GUI includes a user interaction with a single cubic GUI and a user interaction with a group cubic GUI according to an interaction range.

The user interaction with a single cubic GUI is a case in which an interaction with only one selected cubic GUI is generated. In an example, when an interaction for rotating the remote control apparatus 200 is input in a state in which a specific cubic GUI representing a content provider is pointed to, the selected cubic GUI may be rotated to provide content information provided by the content provider. In another example, in a state in which a friend's face is displayed on a front surface of a cubic GUI on a social networking service (SNS) service providing screen, the friend's latest update may be displayed according to an interaction for rotating the cubic GUI.

The user interaction with a group cubic GUI is a case in which interactions with a plurality of cubic GUIs are simultaneously generated. In an example, the selected cubic GUI and another cubic GUI (for example, a cubic GUI included in the same category) related to the selected cubic GUI may be simultaneously rotated to provide specific content information and other content information related to the specific content information. In another example, in a state in which a friend's face is displayed on a front surface of a cubic GUI on an SNS service providing screen, the other cubic GUI is simultaneously rotated with the cubic GUI according to an interaction for rotating the cubic GUI, and thus a plurality of users' faces included in the same group as friends may be displayed.

When the plurality of cubic GUIs included in the same category are simultaneously rotated, the cubic GUIs may be automatically gathered, divided, and stored in corresponding spaces (for example, cubic rooms to be described below).

However, it is understood that the above-described embodiments are merely exemplary, and various exemplary embodiments related to a user interaction and information provision or operation execution according to the user interaction will be described below with reference to the accompanying drawings.

<User Interaction for Cubic GUI List Conversion>

The user interface unit 120 may receive a user interaction for cubic GUI list conversion provided in a displayed specific cubic room.

Specifically, a cubic GUI list may be converted and displayed according to a user interaction with a cubic GUI disposed in a specific location among a plurality of cubic GUIs. For example, when the plurality of cubic GUIs are arranged in a 3*3 matrix form, the cubic GUI list is converted into a next cubic GUI list when there is a preset event for at least one among cubic GUIs disposed on bottom and right sides, and the cubic GUI list is converted into a previous cubic GUI list when a preset event occurs for at least one among cubic GUIs disposed on top and left sides. Here, the cubic GUI list is a list including a predetermined number of cubic GUIs displayed on a screen at once, and may be a list disposed on the basis of a Z-axis of the screen. For example, GUI pages corresponding to the cubic lists may be arranged on the basis of a virtual Z-axis. That is, a GUI page corresponding to a previous list is disposed in a virtual location having a depth of a +Z-axis direction rather than a currently displayed GUI page, and a GUI page corresponding to a next list is disposed in a virtual location having a depth of a −Z-axis direction rather than the currently displayed GUI page.

When the cubic GUI list is provided in a form to display a thumbnail of each piece of content, thumbnail information corresponding to a cubic GUI list disposed in a list conversion direction on the basis of a currently displayed cubic GUI list may be previously generated and stored, and thus fast list conversion may be performed.

In some cases, the user interaction with the cubic GUI list conversion may overlap the user interaction with the cubic GUI described above. For example, a cubic GUI list may be converted according to a preset user interaction with a cubic GUI disposed at a specific location on the screen.

<User Interaction with Arrangement Space of Cubic GUIs>

The user interface unit 120 may receive various user interactions with a 3D space (hereinafter referred to as ‘a cubic room’) in which cubic GUIs are displayed. Specifically, the user interface unit 120 may receive various user commands, such as a user interaction for converting a display angle of a cubic room, a user interaction for converting a displayed cubic room into another cubic room, and a user interaction for converting a main display space (for example, a ceiling, a wall, or a floor) of the cubic room. For example, the user interface unit 120 may sense at least one of an interaction through head rotation of the user and an interaction through head movement of the user through a camera, and transmit the sensed signal to the controller 130 to be described below to allow the display angle of the displayed cubic room to be changed and to allow the cubic room to be displayed. Therefore, the cubic room may be displayed by changing a display angle of a plurality of cubic GUIs therein. In another example, the user interface unit 120 may transmit a remote control signal received from the remote control apparatus 200 to the controller 130 so that a roulette-wheel-like space as described above is rotated, and a first cubic room corresponding to a VOD content-based category displayed on a current screen is converted into a second cubic room corresponding to a network security (NS) content sharing-based category to be displayed. In still another example, when a head up interaction of the user is sensed, the user interface unit 120 may transmit the sensed signal to the controller 130 to display a ceiling portion as a main space.

The controller 130 may operate to control an overall operation of the display apparatus 100.

<Various Exemplary Embodiments for an Interaction with a Cubic GUI>

The controller 130 may control the display 110 to display different types of information according to a type of a user interaction with a cubic GUI.

For example, the controller 130 may control to provide first type information when the user interaction is an interaction for rotating a cubic GUI, and to display second type information when the user interaction is an interaction with one surface of a cubic GUI. Here, the interaction with one surface of a cubic GUI may be at least one of a rubbing interaction and a scroll interaction.

Specifically, in a state in which content provider information is displayed on one surface of a cubic GUI, the controller 130 may control to display content information provided by a content provider when another surface of the cubic GUI is displayed according to the interaction for rotating a cubic GUI, and the controller 130 may control to display detailed information for the content provider according to the rubbing interaction with one surface of a cubic GUI.

Here, the first type information and the second type information may be changed according to an object represented by the cubic GUI. For example, when the object represented by the cubic GUI is content provider information, the first type information may be content information provided by the content provider, and the second type information may be detailed information for the content provider. When the object represented by the cubic GUI is content information, the first type information may be sub content information, and the second type information may be related content information.

For example, when the object represented by the cubic GUI is broadcasting channel information, the first type information may be broadcasting program information provided by the broadcasting channel. When the object represented by the cubic GUI is a 16-part drama, the first type information may be drama information corresponding to each part or episode. In some cases, the first type information and the second type information may be set as default regardless of the object represented by the cubic GUI. For example, the first type information may be detailed information when the object represented by the cubic GUI is the broadcasting channel information as well as when the object represented by the cubic GUI is the broadcasting program information.

The interaction for rotating a cubic GUI itself may be input in various forms. For example, the interaction for rotating a cubic GUI itself may have various forms, such as an interaction according to rotation or movement of a user's head, an interaction according to an input of a remote controller which operates in a pointing mode or a gesture mode, an interaction according to an input of a remote controller button, an interaction according to a voice input, etc.

The user interaction with one surface of a cubic GUI may also be input in various forms. For example, a rubbing interaction may be input by a rubbing operation on a touch panel or an OJ sensor provided in the remote control apparatus 200, and a scroll interaction may be input by a scroll operation on a wheel button provided in the remote control apparatus 200 or by a scroll operation input through a touch panel or an OJ sensor provided in the remote control apparatus 200.

Further, the controller 130 may control to display the first type information providable from another cubic GUI by simultaneously rotating the other cubic GUI related to a cubic GUI with the cubic GUI according to the interaction for rotating the cubic GUI. For example, when a first cubic GUI represents information for a first content provider, and content information provided by the first content provider is displayed on a surface of the first cubic GUI exposed through rotation of the first cubic GUI according to a user interaction, the controller 130 may control to display content information provided by a second content provider on a surface of a second cubic GUI by simultaneous rotation of the second cubic GUI representing information for the second content provider related to the first content provider.

The controller 130 may control to display at least one of detailed information and associated information of content information on one surface of a cubic GUI according to at least one of a rubbing interaction with one surface of a cubic GUI and a scroll interaction with one surface of a cubic GUI in a state in which content information is displayed on the one surface of the cubic GUI. In some cases, recommended information may be displayed. In one example, recommended content information provided by a corresponding content provider may be provided according to at least one of the rubbing interaction and the scroll interaction with one surface of a cubic GUI in a state in which information for the content provider is displayed on the one surface of the cubic GUI. In another example, in a state in which content information is displayed on the one surface of the cubic GUI, detailed information may be displayed according to the rubbing interaction, and displayed detailed information may be scrolled to be displayed when the scroll interaction is input.

The controller 130 may control to display detailed information having different levels according to at least one of an input strength (e.g., rubbing strength) and an input time (e.g., rubbing time) of a rubbing interaction with one surface of a cubic GUI. For example, in a state in which specific content information is displayed on one surface of a cubic GUI, the controller 130 may display detailed information of content corresponding to an input rubbing strength when a rubbing interaction corresponding to the rubbing strength of a first level is input, and may display more detailed information when a rubbing interaction corresponding to rubbing strength of a second level higher than the first level is input. Further, in a state in which information of a series for specific content is to be displayed on one surface of a cubic GUI, the controller 130 may display sub content information corresponding to an N-th episode corresponding to an input rubbing time when a rubbing interaction is input for a preset first time, and may display sub content information corresponding to an M-th (M>N) episode corresponding to an input rubbing time when a rubbing interaction is input for a second time longer than the first time.

The controller 130 may control to provide third type information when the user interaction is an interaction for rotating a single cubic GUI, and to provide fourth type information when the user interaction is an interaction for rotating a group cubic GUI.

For example, in a state in which specific SNS information is displayed on one surface of a cubic GUI, the controller 130 may display other SNS information when the cubic GUI is rotated according to a first user interaction, and display information for a plurality of social users that have joined the SNS on a plurality of cubic GUIs when the plurality of cubic GUIs including the cubic GUI are simultaneously rotated. Here, the plurality of social users may be other users (for example, friend-related users) related to the user of the display apparatus 100.

The controller 130 may simultaneously rotate the other related cubic GUIs even when the user interaction is an interaction for rotating a single cubic GUI. For example, when the single cubic GUI is rotated according to the user interaction and specific content is displayed in a state in which the single cubic GUI represents a specific content provider, the controller 130 may simultaneously rotate at least one cubic GUI providing other content (for example, content of the same genre) related to the content through the rotation. Therefore, the user may simultaneously check content of the same genre provided by different content providers as well as content selected by the user.

The controller 130 may control to display corresponding advertisement information on all of the cubic GUIs displayed on a screen according to a user interaction for selecting the advertisement information in a state in which the advertisement information is displayed on one surface of at least one cubic GUI among a plurality of cubic GUIs displayed on the screen.

Specifically, when the advertisement information displayed on the one surface of the cubic GUI is a preset image, the controller 130 may control to display the preset image on the cubic GUIs individually or to magnify the preset image to one image and display the one image on all of the cubic GUIs.

When at least one cubic GUI is rotated according to a user interaction in a state in which advertisement information is displayed on a plurality of cubic GUIs displayed on a screen, the controller 130 may display specific object information on the rotated cubic GUI. For example, when a corresponding specific cubic GUI is rotated according to the user interaction in a state in which one advertisement image is displayed on the plurality of cubic GUIs displayed on the screen and the specific cubic GUI is pointed to, the controller may display specific content information pre-mapped to the cubic GUI on a cubic surface exposed through the rotation. Accordingly, a product or service provider may provide advertisement information for a product or service through the UI screen according to the exemplary embodiment, and the provider of the display apparatus 100 may receive a payment for advertisement provision from the product or service provider.

The controller 130 may display a cubic GUI by changing at least one of a size, an arrangement state, an angle, etc., of the cubic GUI according to a user interaction with a cubic GUI. Here, the arrangement state may include at least one of a location of the cubic GUI on X- and Y-axes of a screen and a depth of the cubic GUI on a Z-axis of the screen, and the angle may be an angle to which a front of the cubic GUI is directed according to rotation of the cubic GUI.

The controller 130 may arrange and display a plurality of panel GUIs, into which a cubic GUI is sliced according to a user interaction, on a preset axis of the screen. Here, the axis which is a criterion for arrangement of the plurality of panel GUIs may be a Y-axis. However, the axis is not limited thereto, and the panel GUIs may be arranged on the basis of an X-axis or a Z-axis. The user interaction may be an interaction according to a motion of pushing the remote control apparatus 200 in a direction of a screen in a state in which the cubic GUI is pointed to. However, it is understood that one or more other exemplary embodiments are not limited thereto, and the user interaction may include various types of interactions, such as a user motion command, a voice command, a button input of the remote control apparatus 200, etc. The plurality of panel GUIs may include at least one of detailed information, associated information, recommended information of an object represented by the cubic GUI, etc.

The controller 130 may sequentially array and display the plurality of panel GUIs on a preset axis of a screen according to at least one of a generation time of a sub object represented by each of the plurality of panel GUIs, an update time of the sub object, a degree of association of content represented by the sub object and the cubic GUI, etc.

For example, when a cubic GUI represents specific broadcast content, a plurality of panel GUIs having a form into which the cubic GUI is sliced may represent a plurality of pieces of sub content corresponding to turns of the content, and may be sequentially arrayed and displayed on a Y-axis of a screen.

The controller 130 may display a cubic GUI divided into a plurality of sub cubic GUIs according to a user interaction, or display a plurality of cubic GUIs combined into one cubic GUI. For example, when a cubic GUI representing a content provider is divided into a plurality of sub cubic GUIs, the sub cubic GUIs may represent different information provided from the content provider. Alternatively, when a cubic GUI representing content is divided into a plurality of sub cubic GUIs, the sub cubic GUIs may represent different series of the content, or thumbnails of the content. Further, when a plurality of cubic GUIs representing different content are combined into one cubic GUI, the combined cubic GUI may represent upper content including the different content.

The controller 130 may control to display a cubic GUI in a floating form in a 3D space which is formed by three walls along an X-axis of a screen.

The controller 130 may display a plurality of cubic GUIs included in a first cubic GUI list, that is, a current cubic GUI list, in the 3D space in a floating form, and display the plurality of cubic GUIs converted into a plurality of cubic GUIs included in a second cubic GUI list, that is, a next cubic GUI list or a previous cubic GUI list, according to a user interaction received through the user interface unit 120.

Specifically, the controller 130 may convert and display a cubic GUI list according to a list conversion direction pre-mapped to a preset location when a user interaction for list conversion is input in a state in which the GUI displayed in the preset location is pointed to on a screen.

For example, in a state in which the pointing GUI is located in one of five cubic GUIs disposed in lowermost and rightmost locations when nine cubic GUIs are displayed in a 3*3 matrix form in the 3D space displayed on the screen, the controller 130 may control to display cubic GUIs included in the next cubic GUI list when the user interaction for cubic GUI list conversion is input. Alternatively, in a state in which the pointing GUI is located in one of five cubic GUIs disposed in uppermost and leftmost locations, the controller 130 may control to display cubic GUIs included in the previous cubic GUI list when the user command for cubic GUI list conversion is input. However, the cubic GUI list conversion is merely exemplary, and the list conversion direction for display locations of cubic GUIs may be variously set by a manufacturer or a setting of a user.

The controller 130 may control at least one cubic GUI, which is included in a cubic GUI list to be displayed after a cubic GUI list currently displayed on a screen, to be displayed with a preset transparency in at least one of the three walls. For example, the controller 130 may control cubic GUIs included in a next cubic GUI list to be displayed in a form in which the cubic GUIs are translucently displayed on the right wall of the three walls, and control cubic GUIs included in a previous cubic GUI list to be displayed in a form in which the cubic GUIs are translucently displayed on the left wall. Therefore, the user may check in advance that the cubic GUIs displayed on the right wall are displayed according to the list conversion command in a right direction, and the cubic GUIs displayed on the left wall are displayed according to a list conversion command in a left direction.

It is understood that the above-described various GUIs, configurations of GUIs, user interactions, types of information, objects of GUIs, mappings therebetween, etc., may be set by a manufacturer, set by a user, etc.

FIG. 2B is a block diagram illustrating a detailed configuration of a display apparatus 100′ according to another exemplary embodiment. Referring to FIG. 2B, the display apparatus 100′ includes an image receiver 105, a display 110, a user interface unit 120, a controller 130, a storage unit 140 (e.g., storage), a communication unit 150 (e.g., communicator), an audio processor 160, a video processor 170, a speaker 180, a button 181, a camera 182, and a microphone 183. Detailed descriptions of components illustrated in FIG. 2B that are the same as or similar to components illustrated in FIG. 2A will be omitted herein.

The image receiver 105 receives image data through one or more sources. For example, the image receiver 105 may receive broadcast data from an external broadcasting station, receive image data from an external apparatus (for example, a digital versatile disc (DVD) player, a Blu-ray disc (BD) player, and the like), and receive image data stored in the storage unit 140. In particular, the image receiver 105 may include a plurality of image reception modules configured to receive a plurality of images to display a plurality of pieces of content selected by a cubic GUI on a plurality of screens. For example, the image receiver 105 may include a plurality of tuners to simultaneously display a plurality of broadcasting channels.

The controller 130 controls an overall operation of the display apparatus 100 using various programs stored in the storage unit 140.

Specifically, the controller 130 includes a random access memory (RAM) 131, a read only memory (ROM) 132, a main central processing unit (CPU) 133, a graphic processor 134, first to n-th interfaces 135-1 to 135-n, and a bus 136.

The RAM 131, the ROM 132, the main CPU 133, the graphic processor 134, the first to n-th interfaces 135-1 to 135-n, and the like may be electrically coupled to each other through the bus 136.

The first to n-th interfaces 135-1 to 135-n are coupled to the above-described components. One of the interfaces may be a network interface coupled to an external apparatus through a network.

The main CPU 133 accesses the storage unit 140 to perform booting using an operating system (O/S) stored in the storage unit 140. The main CPU 133 performs various operations using various programs, content, data, and the like stored in the storage unit 140.

A command set and the like for system booting is stored in the ROM 132. When a turn-on command is input to supply power, the main CPU 133 copies the O/S stored in the storage unit 140 to the RAM 131 according to a command stored in the ROM 132, and executes the O/S to boot a system. When the booting is completed, the main CPU 133 copies various application programs stored in the storage unit 140 to the RAM 131, and executes the application programs copied to the RAM 131 to perform various operations.

The graphic processor 134 generates a screen including various objects such as an icon, an image, text, and the like using an operation unit and a rendering unit. The operation unit calculates attribute values, such as coordinate values, in which the objects are displayed according to a layout of a screen, shapes, sizes, and colors based on a received control command. The rendering unit generates a screen having various layouts including the objects based on the attribute values calculated in the operation unit. The screen generated in the rendering unit is displayed in a display area of the display 110.

The operation of the above-described controller 130 may be performed by the program stored in the storage unit 140.

The storage unit 140 stores a variety of data such as an O/S software module for driving the display apparatus 100, a variety of multimedia content, a variety of applications, and a variety of content input or set during application execution.

In particular, the storage unit 140 may store data for constituting various UI screens including a cubic GUI provided in the display 110 according to an exemplary embodiment.

Further, the storage unit 140 may store data for various user interaction types and functions thereof, provided information, and the like.

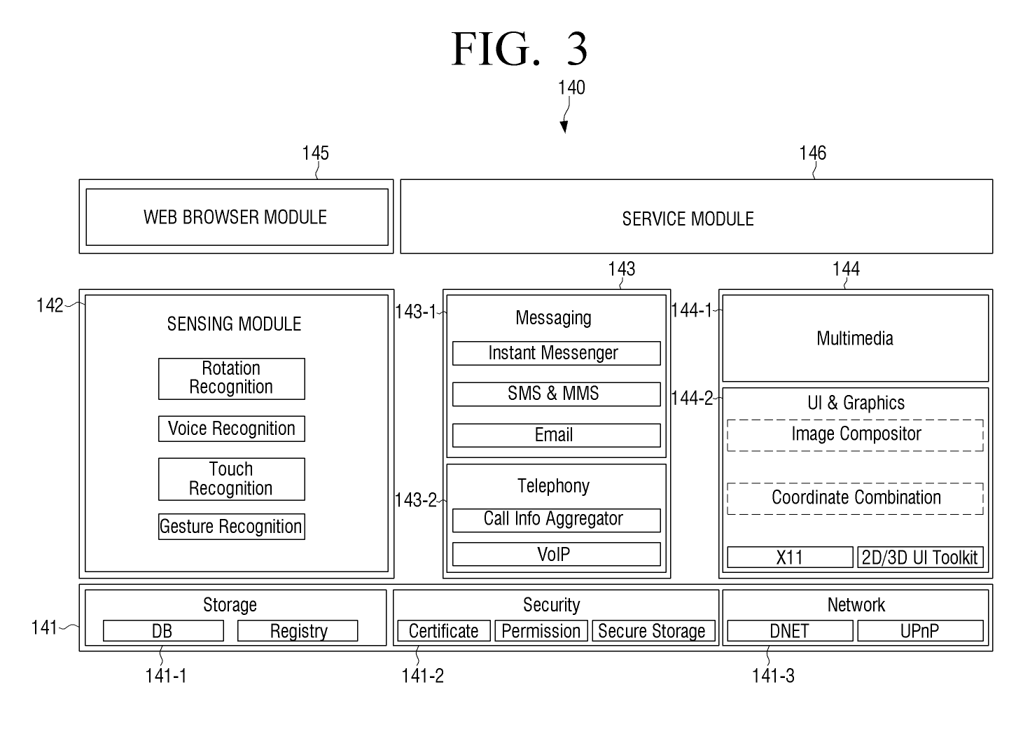

Various software modules stored in the storage unit 140 according to one or more exemplary embodiments will be described in detail with reference to FIG. 3.

Referring to FIG. 3, software including a base module 141, a sensing module 142, a communication module 143, a presentation module 144, a web browser module 145, and a service module 146 may be stored in the storage unit 140.

The base module 141 is a basic module configured to process signals transmitted from hardware included in the display apparatus 100′ and transmit the processed signals to an upper layer module. The base module 141 includes a storage module 141-1, a security module 141-2, a network module 141-3, and the like. The storage module 141-1 is a program module configured to manage a database (DB) or a registry. The main CPU 133 accesses a database in the storage unit 140 using the storage module 141-1 to read a variety of data. The security module 131-2 is a program module configured to support certification to hardware, permission, secure storage, and the like, and the network module 141-3 is a module configured to support network connection, and may include a device Net (DNET) module, a universal plug and play (UPnP) module, and the like.

The sensing module 142 is a module configured to collect information from various sensors, and analyze and manage the collected information. The sensing module 142 may include a head direction recognition module, a face recognition module, a voice recognition module, a motion recognition module, a near field communication (NFC) recognition module, and the like.

The communication module 143 is a module configured to perform communication with the outside. The communication module 143 may include a messaging module 143-1, such as a messenger program, a short message service (SMS) & multimedia message service (MMS) program, and an E-mail program, a call module 143-2 including a call information aggregator program module, a voice over internet protocol (VoIP) module, and the like.

The presentation module 144 is a module configured to construct a display screen. The presentation module 144 includes a multimedia module 144-1 configured to reproduce and output multimedia content, and a UI rendering module 144-2 configured to perform UI and graphic processing. The multimedia module 144-1 may include a player module, a camcorder module, a sound processing module, and the like. Accordingly, the multimedia module 144-1 operates to reproduce a variety of multimedia content, and to generate a screen and sound. The UI rendering module 144-2 may include an image compositor module configured to composite images, a coordinate combination module configured to combine and generate coordinates on a screen in which an image is to be displayed, an X11 module configured to receive various events from hardware, and a 2D/3D UI toolkit configured to provide a tool for forming a 2D type UI or a 3D type UI.

The web browser module 145 is a module configured to perform web browsing to access a web server. The web browser module 145 may include various modules, such as a web view module configured to form a web page, a download agent module configured to perform download, a bookmark module, and a web kit module.

The service module 146 is a module including various applications for providing a variety of services. Specifically, the service module 146 may include various program modules, such as an SNS program, a content-reproduction program, a game program, an electronic book program, a calendar program, an alarm management program, and other widgets.

Various program modules are illustrated in FIG. 3, though it is understood that one or more other exemplary embodiments are not limited thereto. For example, in other exemplary embodiments, one or more of the above-described program modules may be partially omitted, modified, or added according to a kind and characteristic of the display apparatus 100. For example, the storage unit 140 may be implemented in a form further including a location-based module configured to support location-based services in connection with hardware such as a Global Positioning System (GPS) chip.

The communication unit 150 may perform communication with an external apparatus according to various types of communication methods.

The communication unit 150 may include one or more of various communication chips such as a wireless fidelity (WIFI) chip 151, a Bluetooth chip 152, a wireless communication chip 153, etc. The WIFI chip 151 and the Bluetooth chip 152 perform communication in a WIFI manner and a Bluetooth manner, respectively. When the WIFI chip 151 or the Bluetooth chip 152 is used, the communication unit 150 may first transmit/receive a variety of connection information such as a service set identifier (SSID) and a session key, connect communication using the information, and transmit/receive a variety of information. The wireless communication chip 153 is a chip configured to perform communication according to various communication standards, such as Institute of Electrical and Electronics Engineers (IEEE), Zigbee, 3rd generation (3G), 3rd Generation Partnership Project (3GPP), 4th generation, Long Term Evolution (LTE), etc. In addition, the communication unit 150 may further include an NFC chip configured to operate in an NFC manner using a band of 13.56 MHz among various radio frequency identification (RF-ID) frequency bands such as 135 kHz, 13.56 MHz, 433 MHz, 860 to 960 MHz, 2.45 GHz, etc.

In particular, the communication unit 150 may perform communication with a server configured to provide content or a service, or a server configured to provide a variety of information, and receive a variety of information for determining a size and an arrangement state of cubic GUIs. For example, the communication unit 150 may perform communication with an SNS server to receive a plurality of pieces of user information (for example, profile photos and the like) represented by cubic GUIs in an SNS service providing screen, or to receive associated information between users for determining the size and arrangement state of the cubic GUIs. In another example, the communication unit 150 may perform communication with a content providing server to receive content information represented by each of the cubic GUIs in a content providing screen, or associated information between pieces of content.

The audio processor 160 is configured to perform processing on audio data. The audio processor 160 may variously perform processing on the audio data, such as decoding, amplification, and noise filtering for the audio data.

In particular, when a cubic GUI is rotated according to a user's movement in accordance with an exemplary embodiment, the audio processor 160 may process the audio data to provide sound according to a speed of the user's movement. For example, the audio processor 160 may generate feedback sound corresponding to the speed of the user's movement and provide a generated feedback sound.

The video processor 170 is configured to perform processing on video data. The video processor 170 may variously perform image processing on video data, such as decoding, scaling, noise filtering, frame rate conversion, and resolution conversion for the video data.

The speaker 180 is configured to output various alarm sounds or voice messages as well as a variety of audio data processed in the audio processor 160.

The button 181 may include various types of buttons, such as a mechanical button, a touch pad, or a wheel, which are provided in arbitrary regions of an external appearance of a main body of the display apparatus 100, such as a front side, a lateral side, or a rear side. For example, a button for power-on/off of the display apparatus 100 may be provided.

The camera 182 is configured to image (i.e., capture) a still image or a moving image according to control of the user. In particular, the camera 182 may image various user motions for controlling the display apparatus 100.

The microphone 183 is configured to receive a user's voice or another sound, and convert the received user's voice or the sound into audio data. The controller 130 may use the user's voice input through the microphone 183 during a call or may convert the user's voice into audio data, and store the audio data in the storage unit 140. The camera 182 and the microphone 183 may be a configuration of the above-described user interface unit 120 according to a function thereof.

When the camera 182 and the microphone 183 are provided, the controller 130 may perform a control operation according to at least one of the user's voice input through the microphone 183 and the user motion recognized by the camera 182. That is, the display apparatus 100 may operate in at least one of a motion control mode and a voice control mode. When the display apparatus 100 operates in the motion control mode, the controller 130 activates the camera 182 to image the user, traces a change in motion of the user, and performs a control operation corresponding to the motion change. When the display apparatus 100 operates in the voice control mode, the controller 130 analyzes a user's voice input through the microphone, and operates in the voice recognition mode which performs a control operation according to the analyzed user's voice.

When the display apparatus 100 operates in the motion control mode, the controller 130 may control to change a display state of a cubic room and a cubic GUI according to a head movement direction or a head rotation direction of the user, and to display the changed cubic room and cubic GUI. Specifically, the controller 130 may rotate and display the cubic room to have an optimum view at a view point of the user according to the head direction of the user. For example, when the head direction of the user is detected to be on the right with respect to a central portion of a screen, the controller 130 may display a currently displayed cubic GUI in a form rotated in a right direction by rotating the currently displayed cubic GUI so that a front side of the currently displayed cubic GUI has an optimum view in the right direction with respect to the central portion of the screen. In some cases, the controller 130 may display the cubic GUI by tracing a face direction of the user, eyeball movement of the user, and the like to detect a region at which the user is looking, and change and display the display state of the cubic GUI according to the detected region. In another example, when the head direction is rotated, the controller may convert the cubic GUI list to a previous or next cubic GUI list according to a rotation direction and display the converted cubic GUI list.

Alternatively, the controller 130 may determine a face region of the user, determine a gaze location and direction of the user based on a location, an area, and the like of the face region, and control to display at least one of the cubic room and the cubic GUI according to the determined gaze location and direction and display a changed result.

The controller 130 identifies an eyeball image from an image of the user imaged by the camera 182 through face modeling technology. The face modeling technology is an analysis process for processing a facial image acquired by an imaging unit (e.g., the camera 182) and for conversion to digital information for transmission, and one of an active shape modeling (ASM) method and an active appearance modeling (AAM) method may be used. The controller 130 may determine a direction in which the user is looking by determining movement of an eyeball using the identified eyeball image, detecting the direction in which the user is looking using the movement of the eyeball, and comparing pre-stored coordinate information of a display screen with the direction in which the user is looking. As described above, the method of determining the direction in which the user is looking is merely exemplary, and the gaze direction and location of the user may be determined using another method.

Alternatively, the controller 130 may control to display the cubic room and the cubic GUIs by determining a display perspective according to a gaze direction of the user, and changing a display state of at least one of the cubic room and the cubic GUI to correspond to the determined display perspective. Here, the display perspective indicates that the cubic room and the cubic GUI are displayed to represent perspective (far and near distance) on a 2D plane like a display as if being viewed directly with the eyes. Specifically, the display perspective may be a display method in which displayed objects have perspective at a point of view of the user according to a gaze direction and a location of the user. For example, linear perspective may be applied as a display method. The linear perspective may represent a sense of distance and a composition using a vanishing point, that is, a point at which lines intersect when extension lines of objects are drawn in perspective. One-vanishing-point perspective may be referred to as parallel perspective, and has one vanishing point and strong concentration, and may be used in expression of a diagonal composition. Two-vanishing-point perspective may be referred to as oblique perspective, and has two vanishing points which may be located on the left and right of a screen. Three-vanishing-point perspective may be referred to as spatial perspective, and has three vanishing points which may be located on the left and right, and a top or a bottom of a screen.

In addition, the display apparatus 100′ may further include various external input ports for connection to various external terminals, such as a headset, a mouse, a local area network (LAN), etc.

In one or more other exemplary embodiments, the display apparatus 100′ may further include a feedback providing unit (e.g., feedback provider). The feedback providing unit operates to provide various types of feedback (for example, audio feedback, graphic feedback, haptic feedback, and the like) according to the displayed screen. Specifically, the feedback providing unit may provide feedback corresponding to a case in which a cubic room is converted, a case in which a cubic GUI list is converted, a case in which a size and an arrangement of cubic GUIs are changed, and the like. For example, when a priority of a cubic GUI displayed in a rightmost location of the screen is changed according to a user behavior pattern, and the cubic GUI is located in a central portion of the screen, the feedback providing unit may provide the graphic feedback and audio feedback for the cubic GUI.

FIG. 2B illustrates an example of a detailed configuration included in the display apparatus 100′. It is understood that, in one or more other exemplary embodiments, portions of components illustrated in FIG. 2B may be omitted or modified, and other components may be added. For example, when the display apparatus 100′ is implemented in a portable phone, the display apparatus may further include a GPS receiver configured to receive a GPS signal from a GPS satellite, and calculate a current location of the display apparatus 100′, a digital multimedia broadcasting (DMB) receiver configured to receive and process a DMB signal, etc.

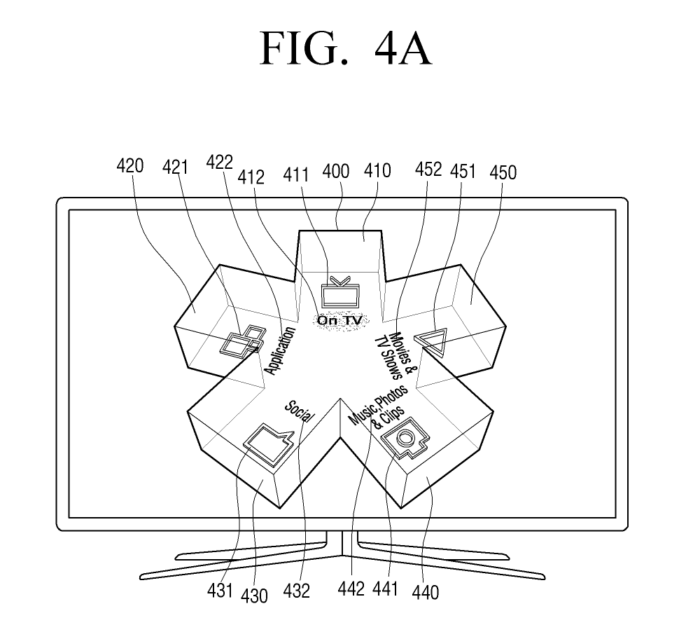

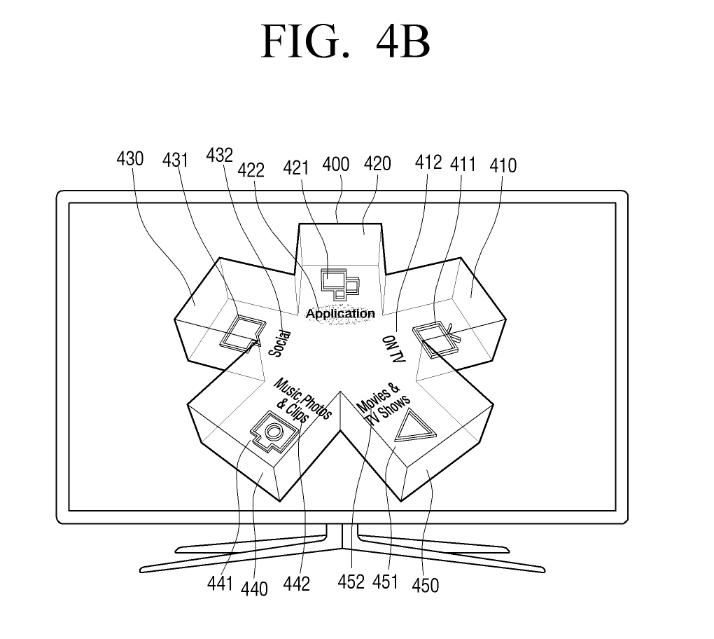

FIGS. 4A and 4B are views illustrating UI screens according to an exemplary embodiment.

Referring to FIG. 4A, a UI screen according to an exemplary embodiment may provide a rotatable GUI 400 including room-shaped 3D spaces 410, 420, 430, 440, and 450, that is, cubic rooms 410, 420, 430, 440, and 450. Specifically, the cubic rooms 410, 420, 430, 440, and 450 may be provided in edges of N-divided spaces having a wheel shape (e.g., roulette wheel shape), and the cubic rooms 410, 420, 430, 440, and 450 may correspond to different categories.

Category information corresponding to each of the cubic rooms may be displayed in a corresponding one of the cubic rooms. Icons 411, 421, 431, 441, and 451 symbolizing categories and simple text information 412, 422, 432, 442, and 452 for the categories may be displayed. As illustrated, the categories may be divided into an “ON TV” category for watching TV in real time, a “Movies & TV shows” for providing VOD content, a “Social” category for sharing SNS content, an “application” category for providing applications, a “Music, Photos & Clips” for providing personal content, and the like. However, it is understood that the aforementioned selection of categories is merely exemplary, and various selections of categories may be provided in other exemplary embodiments.

When a specific cubic room 410 is pointed to, the information 412 representing the cubic room is displayed with highlight to indicate that the cubic room 410 is pointed to.

As illustrated in FIG. 4B, the cubic rooms 410, 420, 430, 440, and 450 are rotated according to a user interaction. That is, a cubic room located in a center may be pointed to according to the rotation, the cubic room may be selected according to a preset event to be displayed in an entire screen in a state in which the cubic room is pointed to, and a cubic GUI included in the selected cubic room may be displayed.

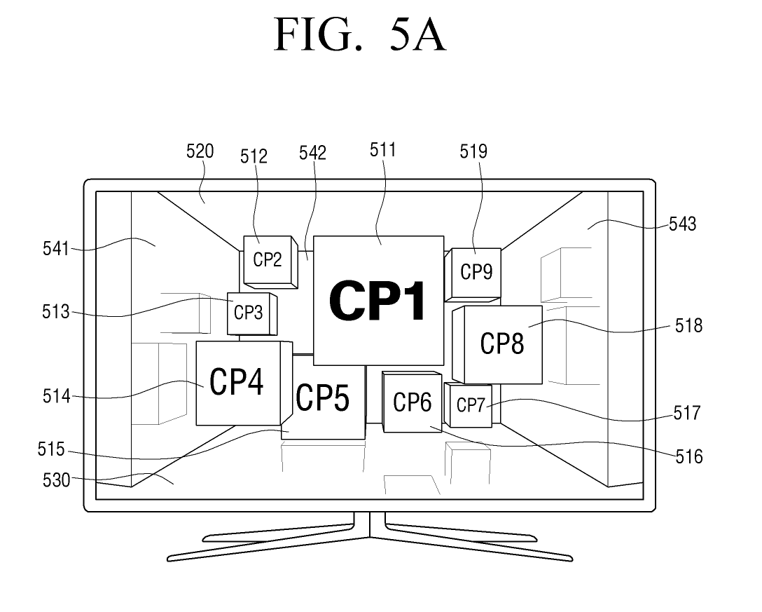

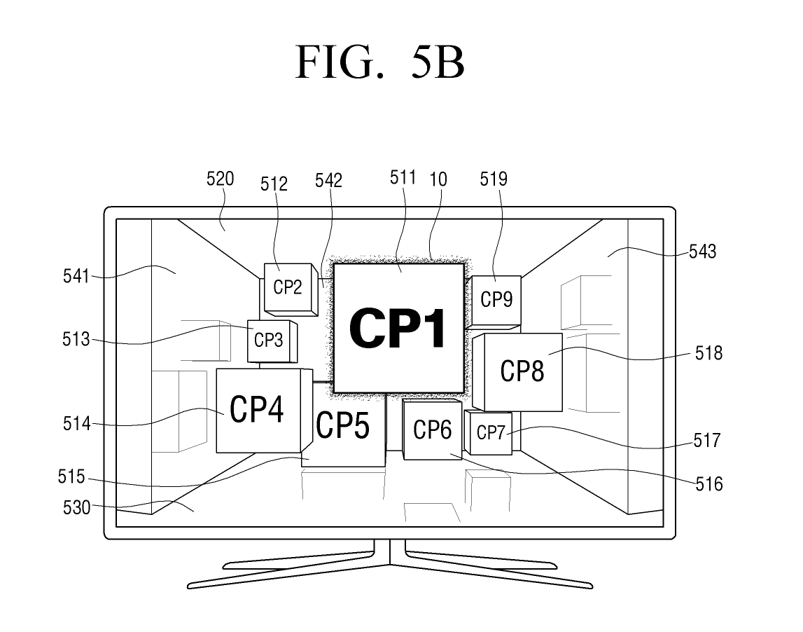

FIGS. 5A and 5B are views illustrating UI screens according to an exemplary embodiment.

FIG. 5A illustrates a case in which a specific cubic room is selected according to a user interaction in the UI screen illustrated in FIGS. 4A and 4B.

When the specific cubic room is selected as illustrated in FIG. 5A, a plurality of cubic GUIs 511 to 519 according to an exemplary embodiment may be displayed in a floating form in a 3D space. As illustrated in FIG. 5A, the 3D space may be a space (e.g., cubic room) having a room shape formed by three walls 541 to 543 arrayed along an X-axis of a screen, and having preset depths along a Z-axis, a ceiling 520, and a floor 530.

As illustrated in FIG. 5B, the plurality of cubic GUIs 511 to 519 may represent predetermined objects (e.g., menu or sub-menu items, selectable items or sub-categories within a category, etc.) Specifically, the plurality of cubic GUIs 511 to 519 may represent a variety of objects included in a category corresponding to a corresponding cubic room. For example, when the cubic room corresponds to a VOD content-based category, the plurality of cubic GUIs 511 to 519 may represent various content providers who provide VOD content. However, it is understood that the above-described plurality of cubic GUIs 511 to 519 are merely exemplary, and the plurality of cubic GUIs 511 to 519 may represent various different content, objects, sub-categories, etc., in one or more other exemplary embodiments. For example, the plurality of cubic GUIs 511 to 519 may represent various specific VOD content provided by content providers according to a menu depth progressed according to the user command.

As illustrated in FIG. 5A, the plurality of cubic GUIs 511 to 519 may be displayed in different sizes and arrangement states. The sizes and arrangement states of the plurality of cubic GUIs 511 to 519 may be changed according to a priority set according to at least one of a user behavior pattern, an object attribute, etc. Specifically, when content having high priority, for example, based on a preference of the user, is a criterion, the cubic GUI 511 representing a user's favorite content provider may be displayed in a central portion of a screen to have a larger size and a smaller depth than other cubic GUIs. That is, the plurality of cubic GUIs 511 to 519 may be displayed to reflect a preference of the user for an object, and thus may provide an effect of increasing a recognition rate of the user for the cubic GUI 511. Other cubic GUIs 512 to 519 may also be displayed to have sizes, locations, and depths according to preferences corresponding thereto.

The user behavior pattern may be analyzed with respect to only a specific user according to a user certification process. For example, the UI according to an exemplary embodiment may be implemented to provide a plurality of users with different UI screens through the certification of the user. That is, since even family members may have different behavior patterns, preferences, and the like from one another, a UI screen corresponding to a behavior pattern of a corresponding user may be provided after a certification process such as a login is performed.

As illustrated in FIG. 5B, a pointing GUI 10 may be displayed to be disposed on the cubic GUI 511 representing an object having highest priority. Here, the pointing GUI 10 operates to select a cubic GUI according to a user command, and may be provided in a highlight pointer form as illustrated. However, the type of the pointing GUI is not limited thereto, and the pointing GUI may be modified in various forms, such as an arrow-shaped pointer, a hand-shaped pointer, a color fill, a pattern fill, etc., in one or more other exemplary embodiments.

The pointing GUI 10 may move according to various types of user commands. For example, the pointing GUI 10 may move to another cubic GUI according to various user commands such as a motion command in a pointing mode of the remote control apparatus 200, a motion command in a gesture mode, a voice command, a direction key operation command provided in the remote control apparatus 200, head (or eye) tracking, etc.

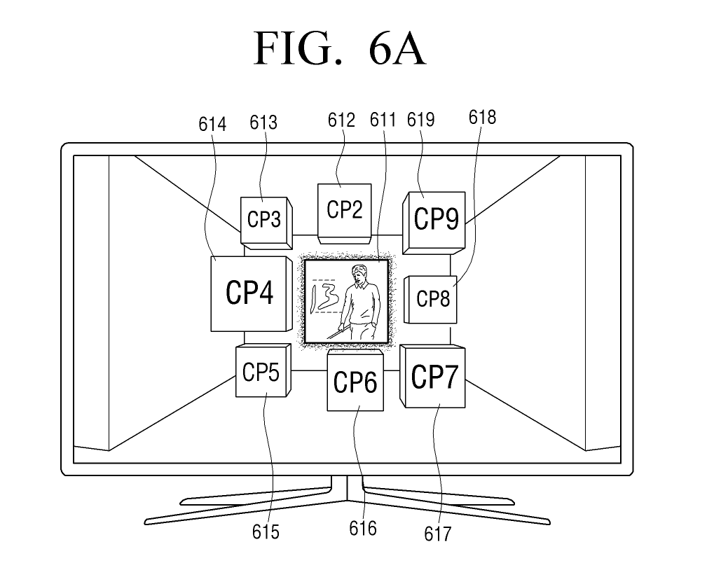

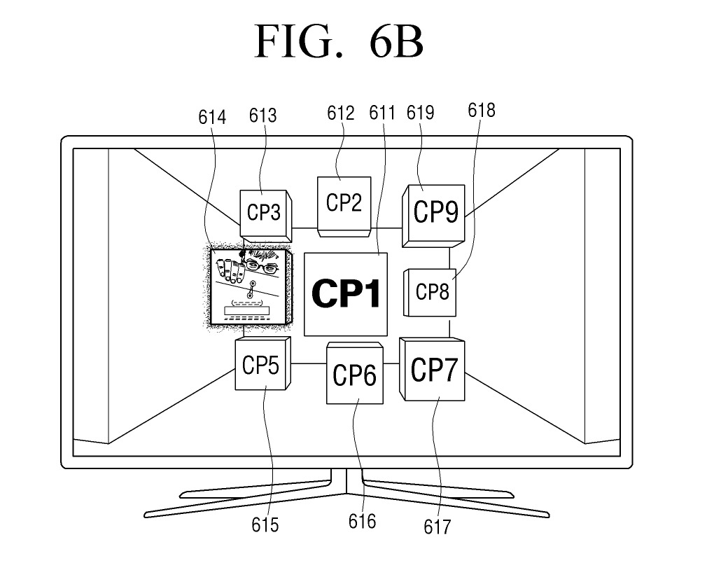

FIGS. 6A and 6B are views illustrating a method of providing information according to a user interaction for pointing to a cubic GUI according to an exemplary embodiment.

As illustrated in FIG. 6A, when a specific cubic GUI 611 is pointed to in a state in which a plurality of cubic GUIs 611 to 619 corresponding to different content providers are displayed, content information provided from the cubic GUI 611 may be displayed in the cubic GUI 611.

Subsequently, as illustrated in FIG. 6B, when another cubic GUI 614 is pointed to according to the user interaction, content information provided by a content provider represented by the cubic GUI 614 may be displayed in the cubic GUI 614. At this time, a display state of the cubic GUI 611 previously pointed to may be changed to display content provider information again.

Additionally, when content information is provided, an animation effect such as rotation of a cubic GUI may be provided. That is, a cubic GUI currently pointed to may provide content information while the cubic GUI rotates, and a cubic GUI previously pointed to may return to a previous state according to rotation, and represent content provider information.

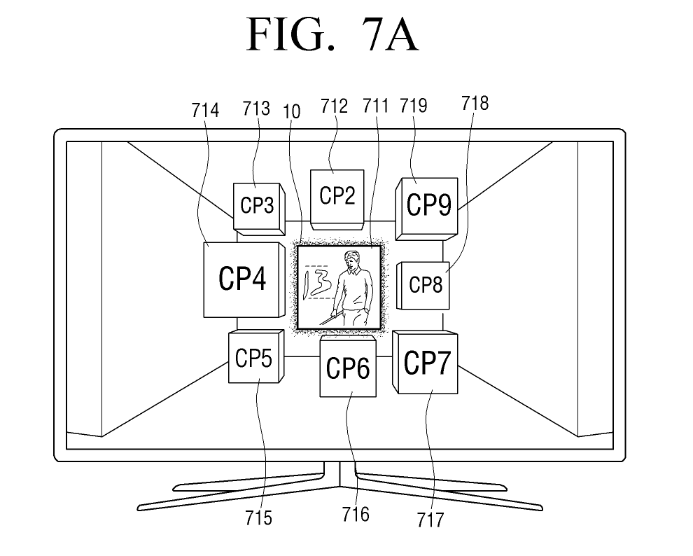

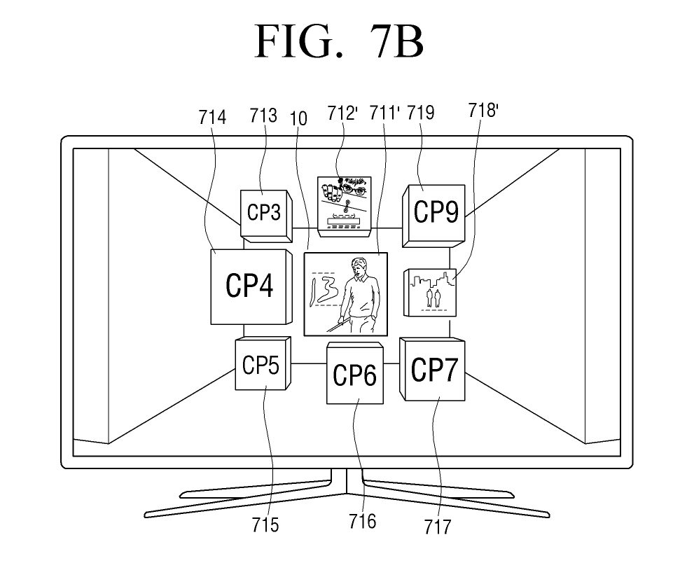

FIGS. 7A and 7B are views illustrating a method of providing information according to a rotation interaction according to another exemplary embodiment.

As illustrated in FIG. 7A, when a user interaction for rotating a specific cubic GUI 711 is input after or when the specific cubic GUI 711 is pointed to according to a highlighted GUI 10 in a state in which a plurality of cubic GUIs represent different content provider information from each other, other cubic GUIs 712 and 718 related to the cubic GUI 711 as well as the cubic GUI 711 may be rotated simultaneously or sequentially. Alternatively, the cubic GUIs 712 and 718 may be sequentially rotated according to a priority thereof. Here, the other cubic GUIs 712 and 718 related to the cubic GUI 711 may include, for example, a case in which content provider information of the other cubic GUIs 712 and 718 displayed before the rotation of the cubic GUI 711 is associated with or similar to that of the specific cubic GUI 711, and a case in which content provider information of the other cubic GUIs 712 and 718 displayed after the rotation of the cubic GUI 711 is associated with or similar to that of the specific cubic GUI 711.

Association of the content provider information may be determined according to various cases, for example, a case in which content attributes provided by the content providers are similar to each other, a case in which a service in connection therewith is provided, etc. Further, association of SNS service providers may be determined according to various cases, for example, a case in which the same social subscriber is included, a case in which a service in connection therewith is provided, etc., when each of cubic GUIs represents an SNS provider.

Association of the content information provided in the cubic GUIs according to rotation may be determined according to various cases, for example, a case in which content genres are the same, a case in which performers or producers are the same, a case in which update times of content are the same or similar to a predetermined degree, etc.

As illustrated in FIG. 7B, rotated cubic GUIs 711′, 712′, and 718′ may represent content information provided by content providers on cubic surfaces exposed by rotation.

In some cases, a cubic GUI which has been determined not to be associated with the cubic GUI 711 but to be associated with the other cubic GUIs 712 and 718 simultaneously rotated is additionally rotated to be displayed.

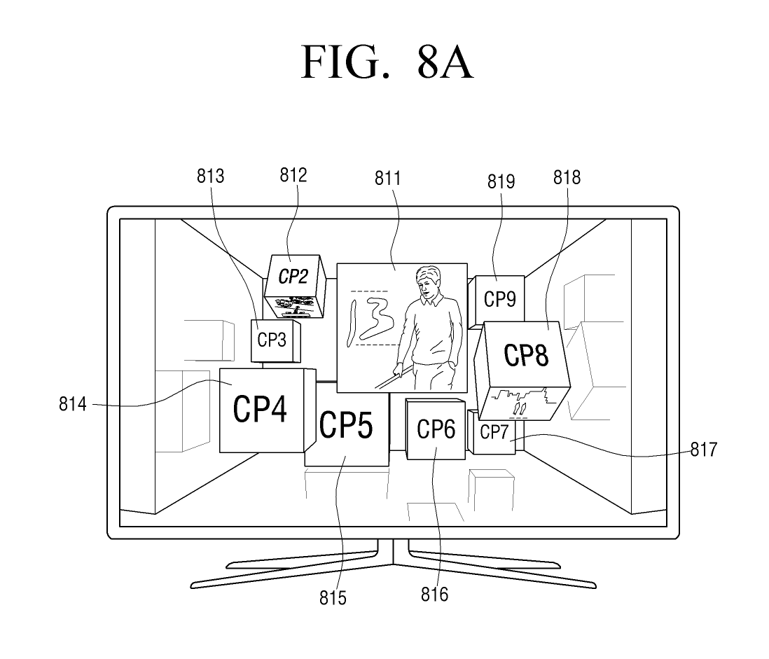

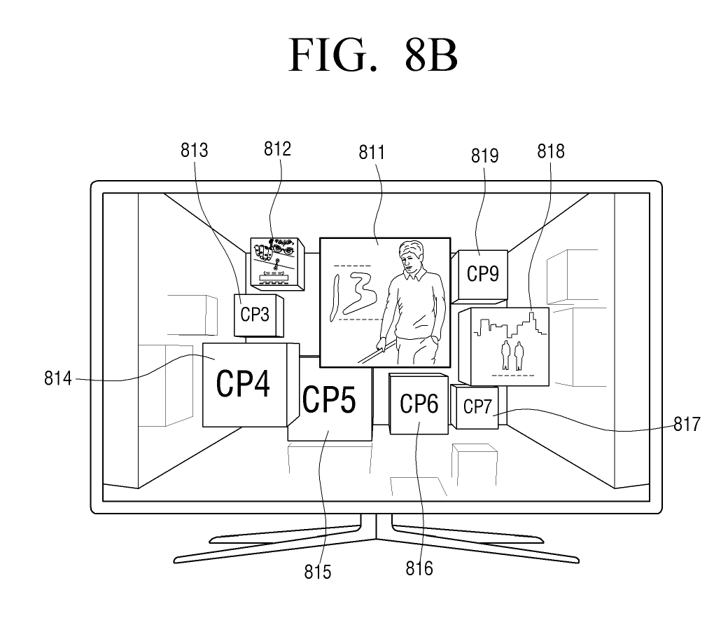

FIGS. 8A and 8B are views illustrating a method of providing information according to a rotation interaction according to another exemplary embodiment.

When a plurality of cubic GUIs 811 to 819 represent different content provider information from each other and a cubic GUI 811 of the plurality of cubic GUIs 811 to 819 is rotated to represent content information as illustrated in FIG. 8A, content information provided on surfaces exposed by simultaneously or sequentially rotating cubic GUIs 812 and 818 providing content related to content provided from the cubic GUI 811 or content similar to the cubic GUI 811 may be represented as illustrated in FIG. 8B. In some cases, cubic GUIs providing related content or similar content may be sequentially rotated according to priorities thereof.

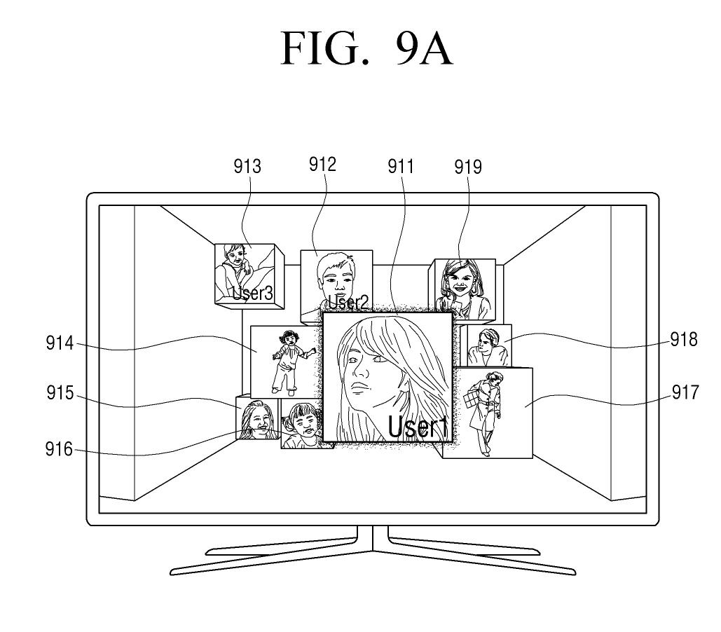

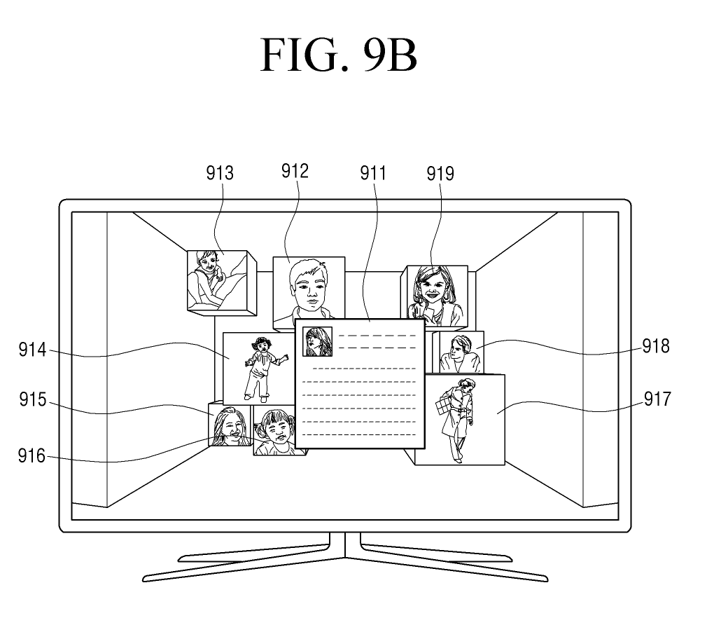

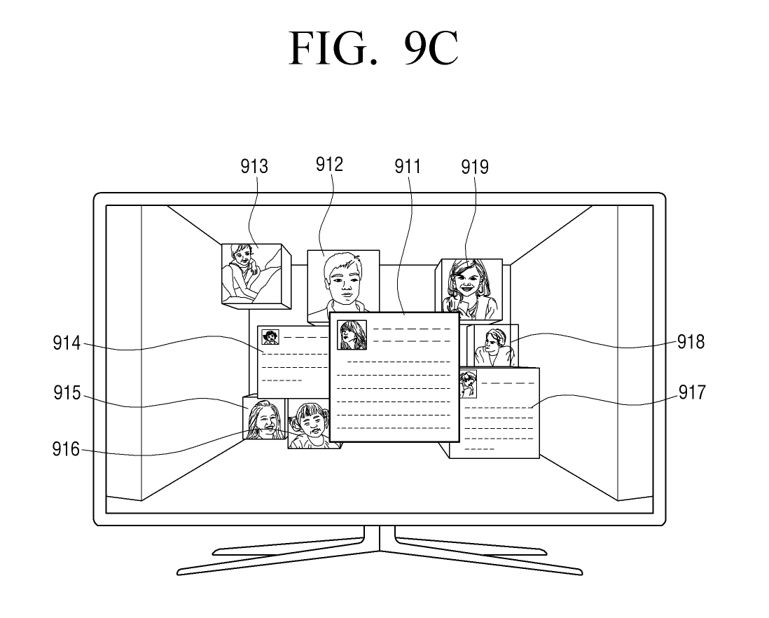

FIGS. 9A to 9C illustrate a method of providing information according to a rotation interaction according to another exemplary embodiment.

As illustrated in FIG. 9A, cubic GUIs 911 to 918 represent information for different users on an SNS providing screen. For example, the cubic GUIs 911 to 918 may represent profile photos of the users and user identification information user1 to user 9.

Subsequently, as illustrated in FIG. 9B, when a specific cubic GUI 911 is rotated and another surface thereof is displayed according to a rotation interaction with the specific cubic GUI 911, content updated recently (or most recently) by a corresponding user may be displayed. In one or more other exemplary embodiments, the displayed content may vary, e.g., one or more most recent updated photos, one or more most viewed, liked, or commented on content, one or more most viewed, liked, or commented on content among most recently updated content, etc.

As illustrated in FIG. 9C, while cubic GUIs 914 and 917 representing other users included in the same group as the specific cubic GUI 911 and a corresponding user are simultaneously rotated with the cubic GUI 911 according to a rotation interaction with the specific cubic GUI 911, content updated recently by the user may be displayed.

That is, as illustrated in FIGS. 9B and 9C, although only the specific cubic GUI 911 is rotated to provide new information according to the rotation interaction with the specific cubic GUI 911, other cubic GUIs 914 and 917 related to the specific cubic GUI 911 may be rotated with (or sequentially to) the specific cubic GUI 911 to provide new information.

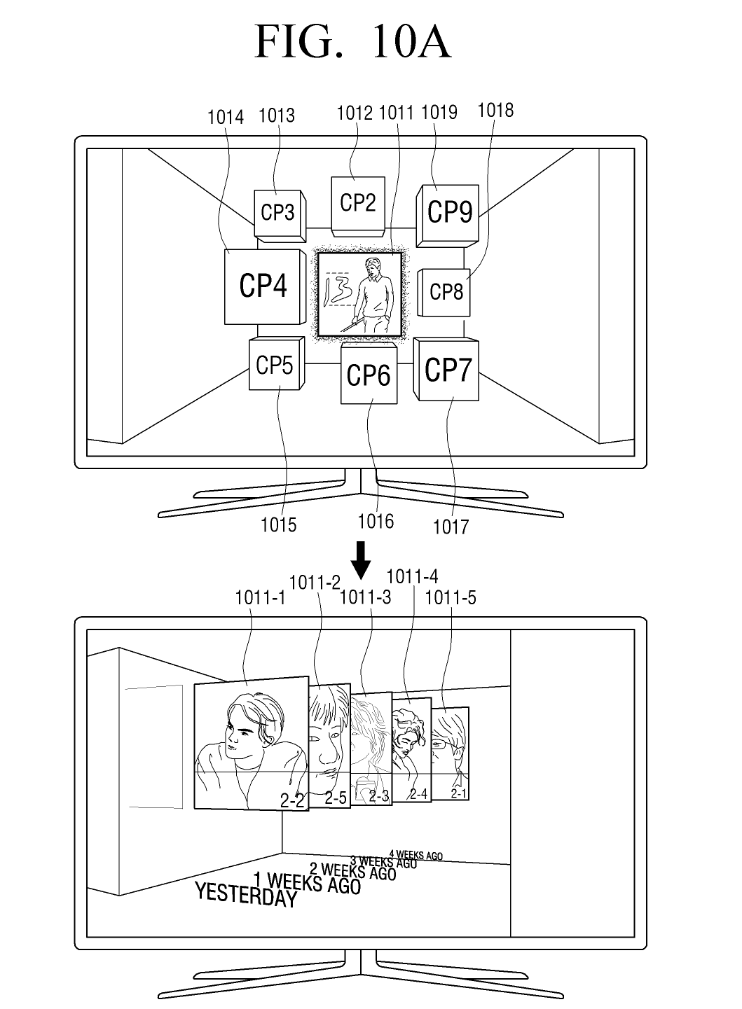

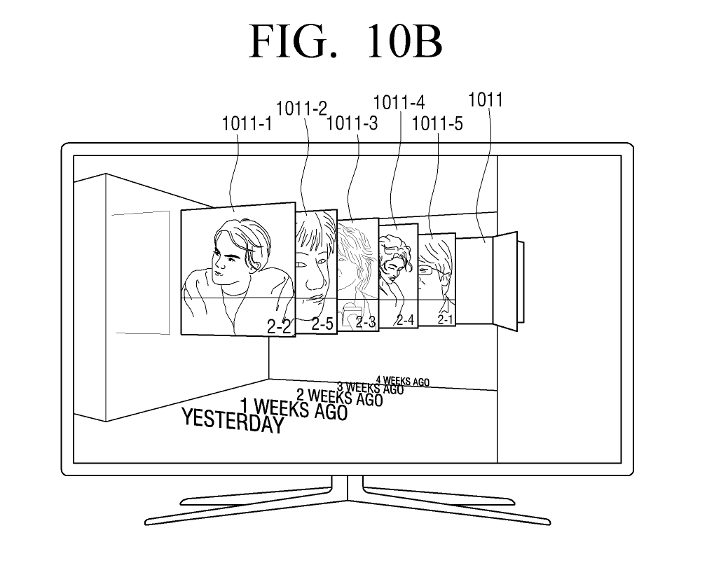

FIGS. 10A and 10B are views illustrating a method of providing information according to a slice interaction according to another exemplary embodiment.

When a slice interaction with a cubic GUI 1011 representing specific content among a plurality of cubic GUIs 1011 to 1019 displayed on a screen is input as illustrated in FIG. 10A, the cubic GUI 1011 may be sliced to be displayed in a form of a plurality of panel GUIs 1011-1 to 1011-5 as illustrated in FIG. 10B. At this time, a user interaction has various types, and a predetermined type among the various types may correspond to a slice interaction. For example, the predetermined type of user interaction may be an interaction according to a motion of pushing the remote control apparatus 200 in a direction of a screen in a state in which the cubic GUI 1011 is pointed to.

The plurality of panel GUIs 1011-1 to 1011-5 may be pieces of sub content corresponding to detailed information represented by a corresponding cubic GUI 1011, for example, a plurality of different series of a content provider represented by the cubic GUI 1011, episodes of a series represented by the cubic GUI, etc. However, it is understood that one or more other exemplary embodiments are not limited thereto. For example, in one or more other exemplary embodiments, the panel GUIs 1011-1 to 1011-5 may represent detailed information, associated information, recommended information, etc., of various objects represented by the cubic GUI.

At this time, as illustrated in FIG. 10A, the plurality of panel GUIs 1011-1 to 1011-5 may be displayed in a form in which the plurality of panel GUIs are sequentially arrayed on a preset axis of a screen according to a preset criterion. For example, the plurality of panel GUIs may be sequentially arrayed according to an update time of sub content, a popularity of sub content, etc., although it is understood that one or more other exemplary embodiments are not limited thereto.

As illustrated in FIG. 10B, when a cubic GUI 1011 has a closeable and openable structure, a graphic effect as if the plurality of panel GUIs 1011-1 to 1011-5 are provided while one surface of a cubic GUI is open may be provided.

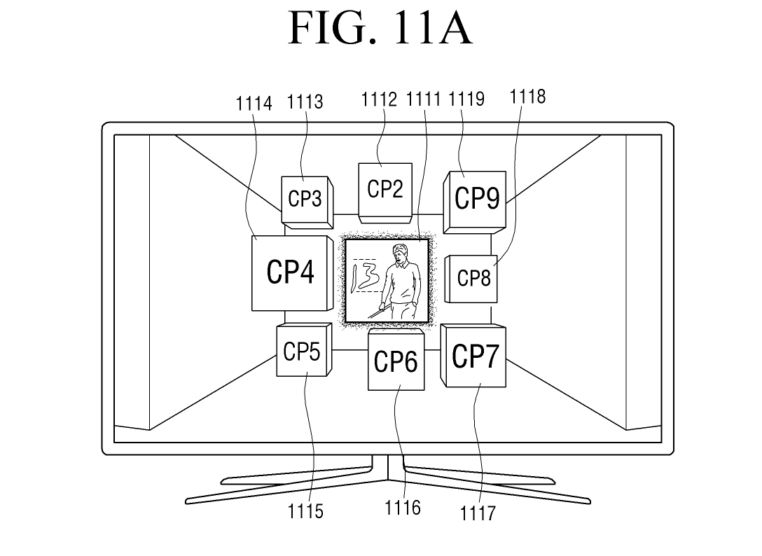

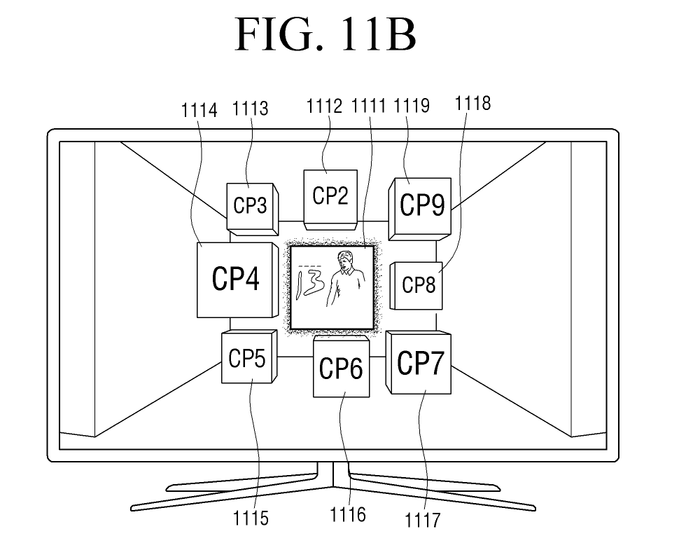

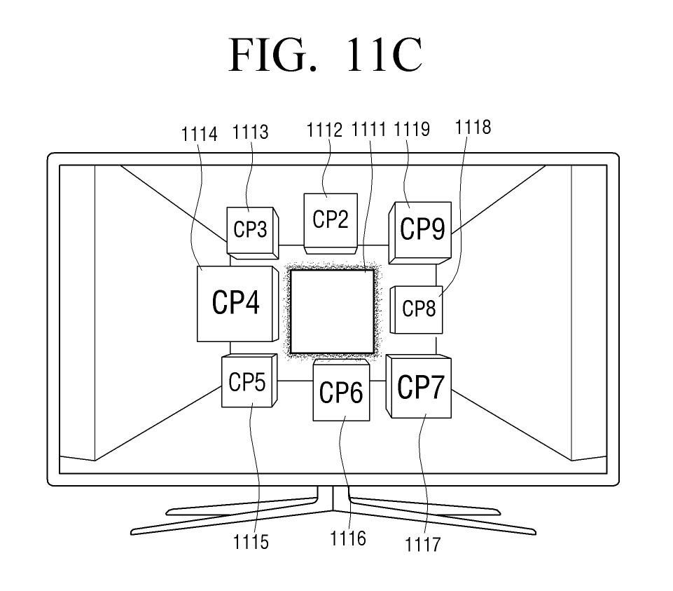

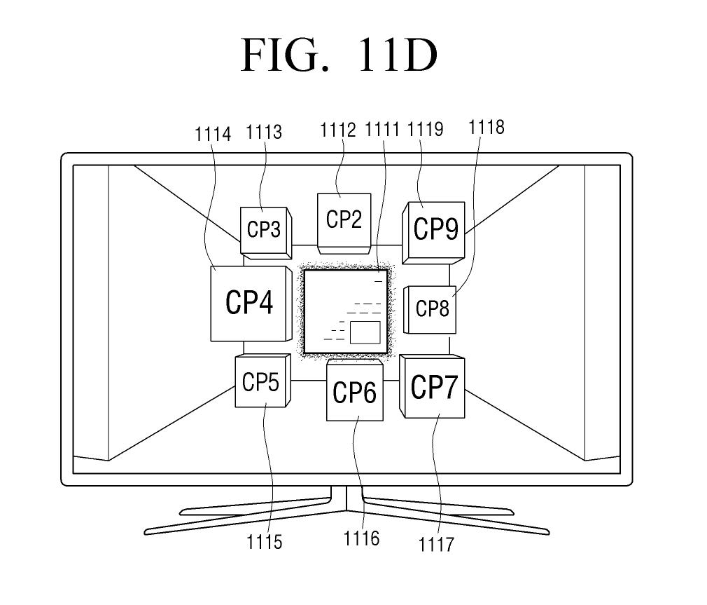

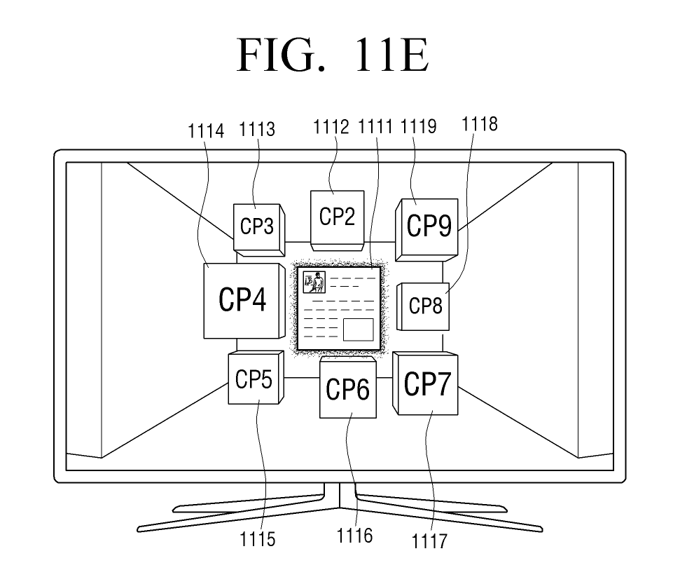

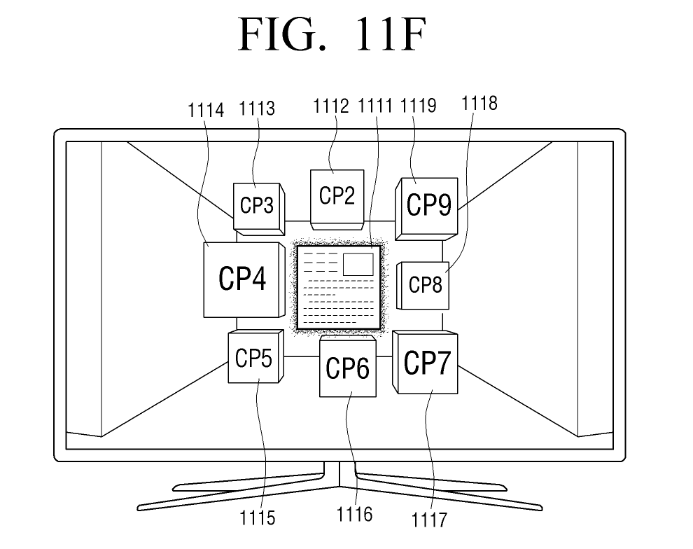

FIGS. 11A to 11F are views illustrating a method of providing information according to a user interaction with a cubic surface according to another exemplary embodiment.

When a predetermined type of user interaction, e.g., a rubbing interaction, with a corresponding cubic GUI 1111 is input in a state in which the cubic GUI 1111 representing content information among a plurality of cubic GUIs 1111 to 1119 displayed on a screen is pointed to as illustrated in FIG. 11A to 11D, new information may be displayed while content information displayed in a rubbed portion is sequentially removed. That is, as illustrated in FIGS. 11A to 11D, although new information may be displayed after existing information is entirely removed, new information may be sequentially displayed in the removed portion and the existing information and the new information may coexist.

As illustrated in FIG. 11E, detailed information of corresponding content may be completely provided. At this time, the rubbing interaction may be in various forms, and in one example, the rubbing interaction may be a rubbing interaction with a touch panel provided on the remote control apparatus 200. However, it is understood that one or more other exemplary embodiments are not limited thereto. For example, when the remote control apparatus 200 is implemented as a flexible apparatus according to another exemplary embodiment, the rubbing interaction may be implemented as an interaction for rubbing the remote control apparatus 200 itself or an interaction by a specific button input on the remote control apparatus 200. Additionally, where the display apparatus 100 includes a touch screen or an embedded user interface according to another exemplary embodiment, the rubbing interaction may be implemented as an interaction for rubbing the touch screen itself or an interaction by a specific button input on the embedded user interface.

When a scroll interaction with a cubic surface on which detailed information for content is displayed is input, as illustrated in FIG. 11F, new detailed information may be scrolled according to a scroll direction to be displayed. At this time, the scroll interaction may be input in various forms, and in an example, the scroll interaction may be a motion interaction for moving the remote control apparatus 200 upward or downward. However, it is understood that one or more other exemplary embodiments are not limited thereto, and the scroll interaction may be input in various forms, such as a touch dragging interaction having directivity on a touch screen, an OJ sensor provided in the remote control apparatus 200, an interaction for scrolling a wheel provided in the remote control apparatus 200, etc.

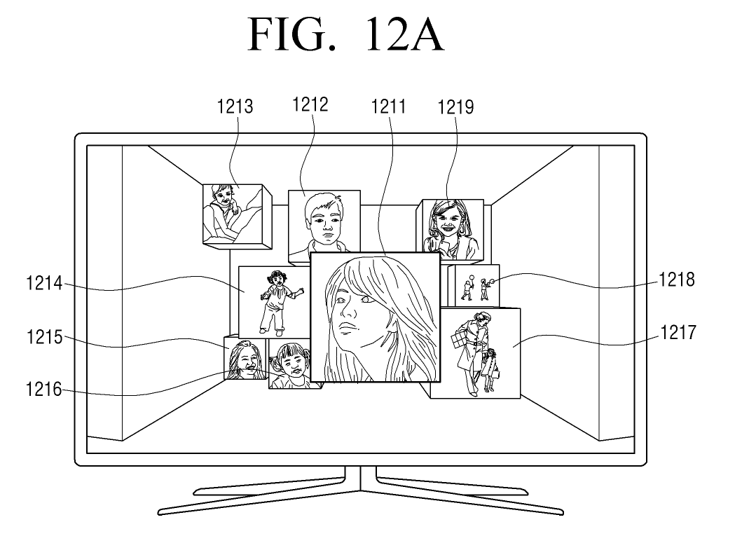

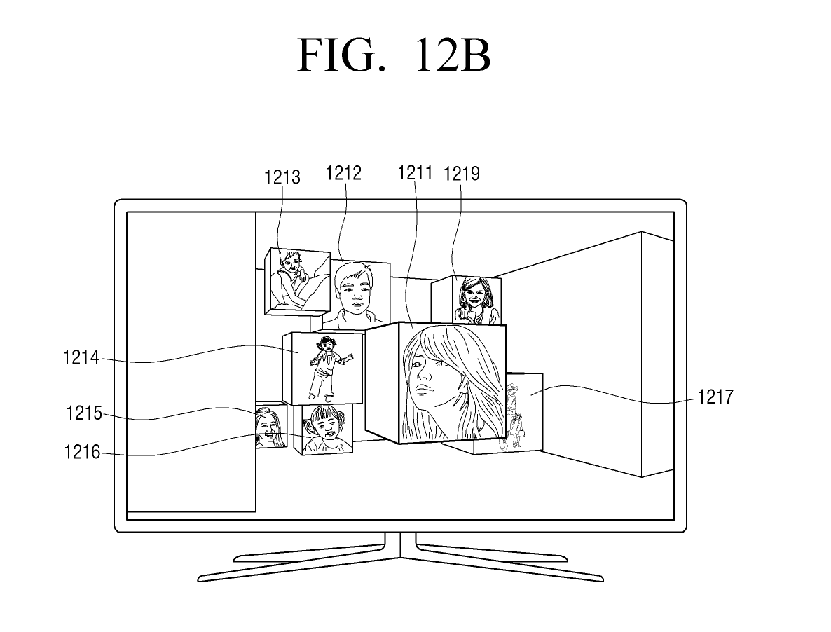

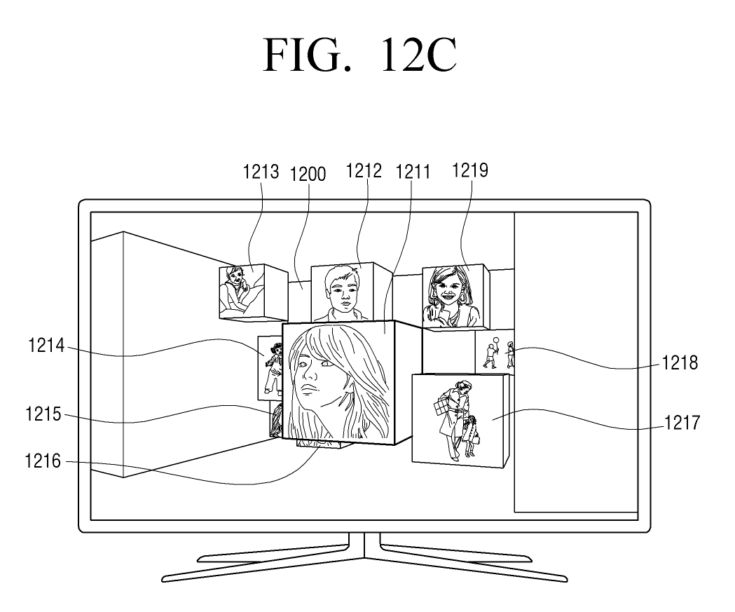

FIGS. 12A to 12C illustrate a method of providing information according to a user interaction with a cubic room according to another exemplary embodiment.

FIGS. 12A to 12C illustrate that a cubic room and cubic GUIs included in the cubic room may be displayed in various angles according to a user interaction.

As illustrated in FIG. 12A, a cubic room 1200 and cubic GUIs 1211 to 1219 included in the cubic room 1200 are basically displayed such that the front faces of the cubic GUIs 1211 to 1219 are facing forward. That is, the front face display may be performed when first entering a corresponding UI screen. At this time, sides of portions of the cubic GUIs 1211 to 1219 may be displayed so that the cubic GUIs are three-dimensionally displayed, but the cubic GUIs 1211 to 1219 may be basically displayed in a form in which the cubic GUIs 911 to 919 face forward.

As illustrated in FIG. 12B, a cubic room 1200 and cubic GUIs 1211 to 1219 included in the cubic room 1200 are displayed in a form in which left sides of the cubic GUIs 1211 to 1219 are viewed in a larger area than a preset area according to a user interaction. For example, as illustrated in FIG. 12B, the cubic room 1200 and the cubic GUIs 1211 to 1219 included in the cubic room 1200 may be displayed in a form shown to the user when peeping into the cubic room 1200 on the left of the cubic room 1200. As illustrated in FIG. 12B, the cubic GUIs 1211 to 1219 may be displayed in a form in which partial areas of portions of the cubic GUIs 1217 to 1219 on the right are covered by other cubic GUIs. Here, a user interaction may be a motion in which the user moves to the left area on the basis of a front of a screen. That is, the user interaction may be a case in which a user's head, face, eyeball, or the like is sensed. However, it is understood that one or more other exemplary embodiments are not limited thereto, and the user interaction may be of various types, such as a specific motion command (for example, movement or rotation of a head (or eye)) of the user, a motion command (pointing or rotation) of a remote controller, a key operation of a remote controller, a voice command, an input of a predetermined type on a touch screen, etc.

As illustrated in FIG. 12C, a cubic room 1200 and cubic GUIs 1211 to 1219 included in the cubic room 1200 are displayed in a form in which right sides of the cubic GUIs 1211 to 1219 are viewed in a larger area than a preset area according to a user interaction. In some cases, advertisement information may be displayed on the right sides. The display method of FIG. 12C is similar to that of FIG. 12B, and thus a detailed description thereof will be omitted herein.

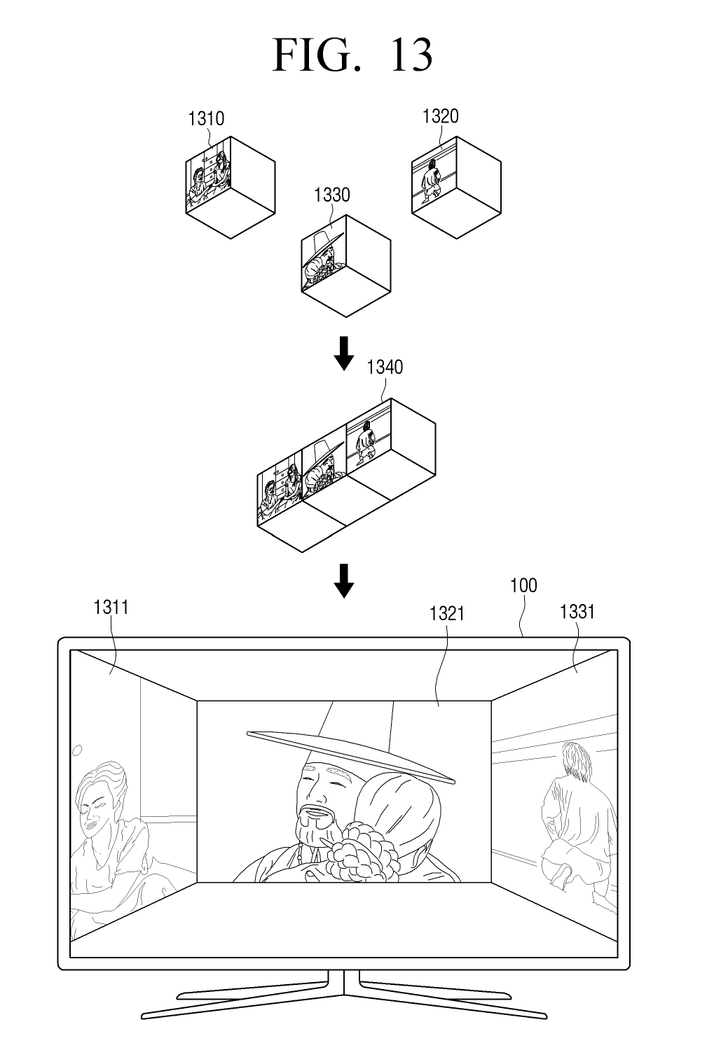

FIG. 13 is a view illustrating a method of converting a screen according to a user interaction according to another exemplary embodiment.

As illustrated in FIG. 13, when a plurality of cubic GUIs 1310, 1320, and 1330 representing different content are selected according to a user interaction, the plurality of cubic GUIs are combined into one cubic GUI 1340, and a plurality of screens 1311, 1321, and 1331 in which content represented by the cubic GUIs 1310, 1320, and 1330 is reproduced and provided may be displayed. For example, as illustrated in FIG. 13, the plurality of screens may include a main screen disposed in a central portion of a screen, and first and second sub screens disposed on the left and right of the screen. However, this is merely exemplary, and the plurality of screens which reproduce a plurality of pieces of content represented by the cubic GUIs 1310, 1320, and 1330 may be implemented in various forms according to one or more other exemplary embodiments.

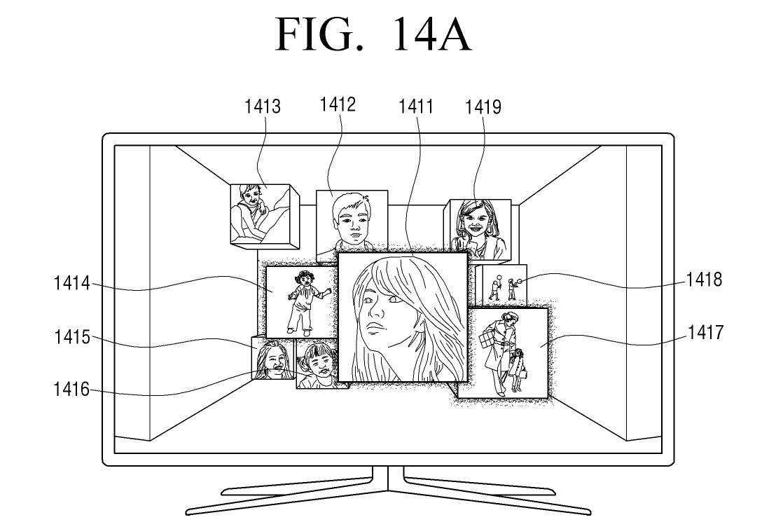

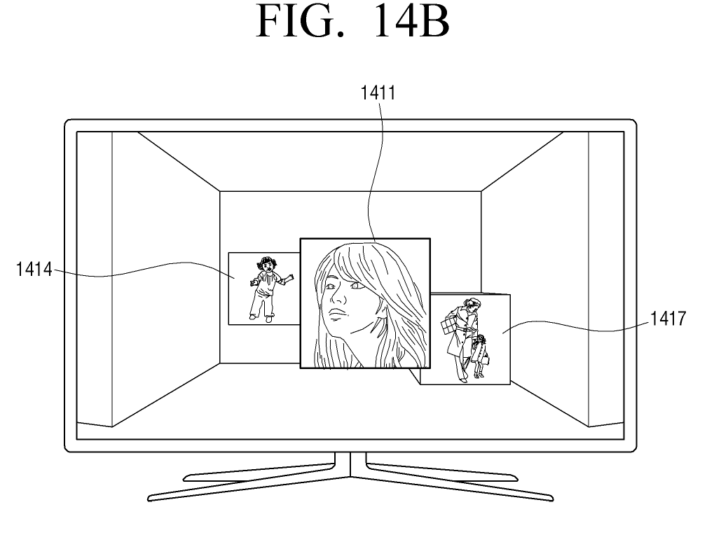

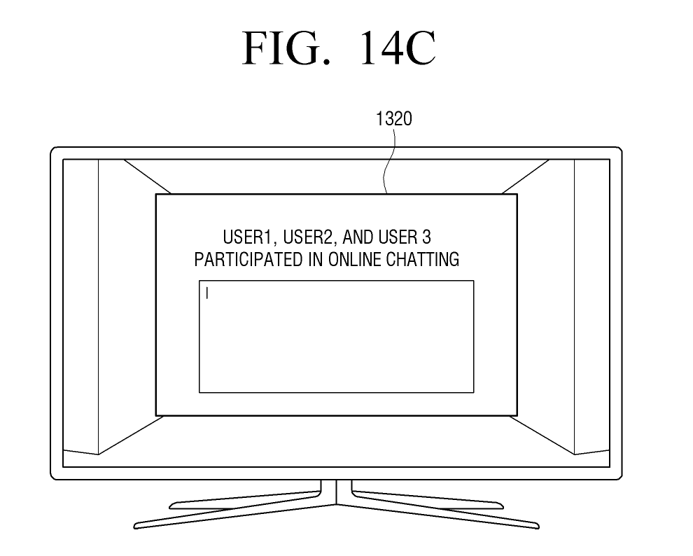

FIGS. 14A to 14C are views illustrating a method of converting a screen according to a user interaction according to another exemplary embodiment.

In a state in which an SNS providing screen in which a plurality of cubic GUIs represent a plurality of users is provided as illustrated in FIG. 14A, only some selected cubic GUIs 1411, 1414, and 1417 may be displayed on a screen as illustrated in FIG. 14B, and other cubic GUIs may disappear from the screen according to a user interaction for selecting only some cubic GUIs 1411, 1414, and 1417.

Subsequently, as illustrated in FIG. 14C, the selected cubic GUIs 1411, 1414, and 1417 are combined to display a chatting window in which the users represented by the cubic GUIs 1411, 1414, and 1417 are participating. However, this is merely exemplary, and in another exemplary embodiment, a video chatting image in which the users are participating may be displayed or images of the users may be provided on a multiscreen.

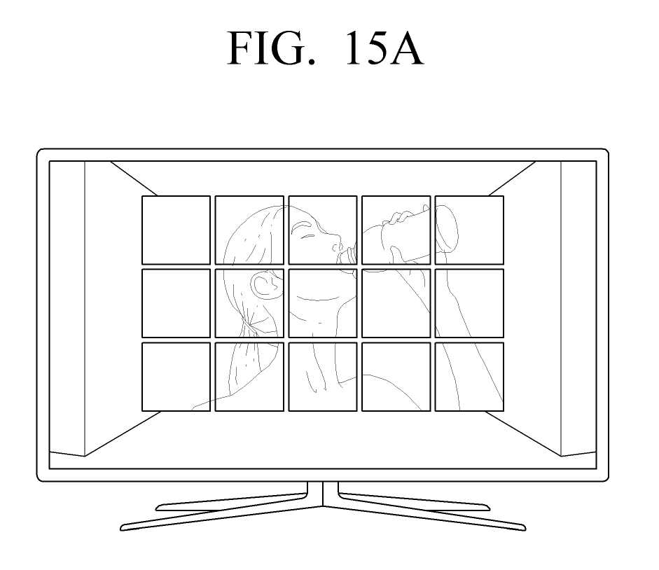

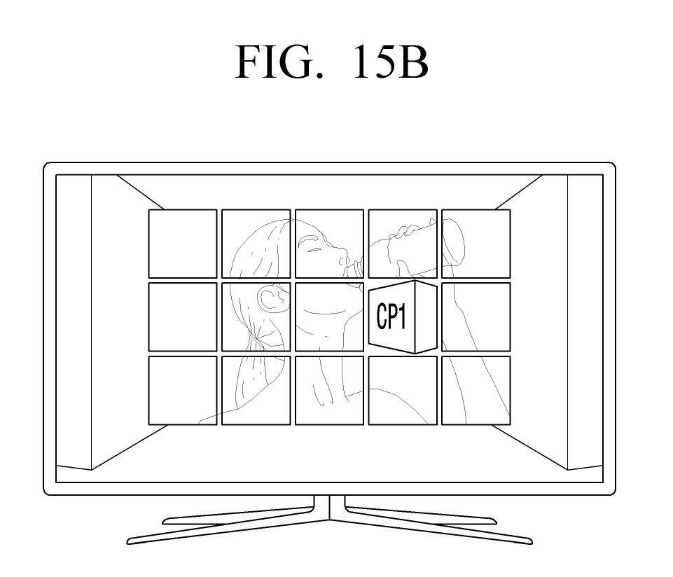

FIGS. 15A and 15B are views illustrating a method of providing advertisement information according to a user interaction according to another exemplary embodiment.

As illustrated in FIG. 15A, advertisement information for a specific product or service may be displayed on a plurality of cubic GUIs displayed on the screen. The advertisement information may be displayed according to a preset event. For example, according to an exemplary embodiment, the preset event may be a standby event. In the case of the preset event being the standby event in which a user interaction is not input for a preset time, the user interaction may be a case in which the user selects the advertisement information displayed in a specific cubic GUI upon the arrival of an advertisement time set as default.

As illustrated in FIG. 15A, the advertisement information may be displayed in a form in which one advertisement image is provided in a plurality of cubic GUIs. However, in another example, the plurality of cubic GUIs may display a plurality of advertisement images.

Subsequently, as illustrated in FIG. 15B, when a specific cubic GUI is rotated according to a user interaction with the specific cubic GUI, object information matching the specific cubic GUI may be displayed on a surface exposed through the rotation. For example, specific content provider information may be displayed on the exposed surface of the cubic GUI.

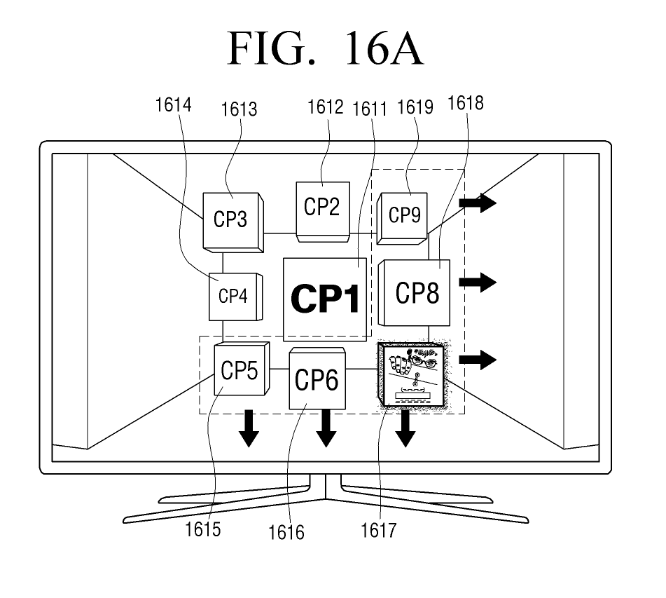

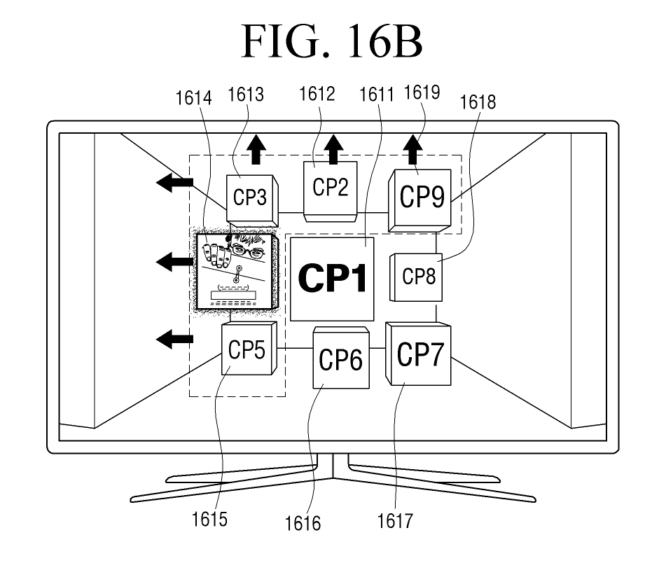

FIGS. 16A and 16B are views illustrating a method of a list conversion interaction according to an exemplary embodiment.

FIGS. 16A and 16B illustrate an example in which a cubic GUI list is converted into a previous cubic GUI list or a next cubic GUI list according to a user interaction.

As illustrated in FIG. 16A, when a plurality of cubic GUIs 1611 to 1619 are arranged in a 3*3 matrix form, a cubic GUI list may be converted into a next cubic GUI list when there is a preset event for cubic GUIs 1615 to 1619 disposed on bottom and right sides. The next cubic GUI list may be displayed when there is a preset user interaction in a state in which the cubic GUI 1617 disposed on the bottom and right sides is pointed to.

As illustrated in FIG. 16B, the cubic GUI list may be converted into a previous cubic GUI list when there is a preset event for cubic GUIs 1612 to 1615, and 1619 disposed on bottom and left sides. For example, the previous cubic GUI list may be displayed when there is a preset user interaction in a state in which the cubic GUI 1614 disposed on the bottom and left sides is pointed to.

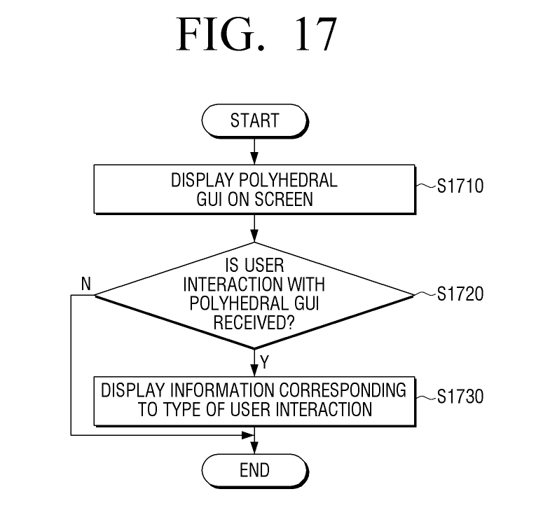

FIG. 17 is a view illustrating a UI screen providing method according to an exemplary embodiment.

According to the UI screen providing method as illustrated in FIG. 17, a screen including a polyhedral GUI, for example, a cubic GUI, is displayed on a screen (operation S1710).

Subsequently, when a user interaction with the cubic GUI is received (operation S1720:Y), information corresponding to the received user interaction type is displayed or a function corresponding to the received user interaction type is executed (operation S1730). At this time, different information may be displayed or different operations may be executed, according to the user interaction type. For example, with respect to a rubbing interaction with one surface of a cubic GUI of an object represented by the cubic GUI, detailed information of the object may be provided. Other specific examples have been described above, and thus detailed descriptions thereof will be omitted herein.

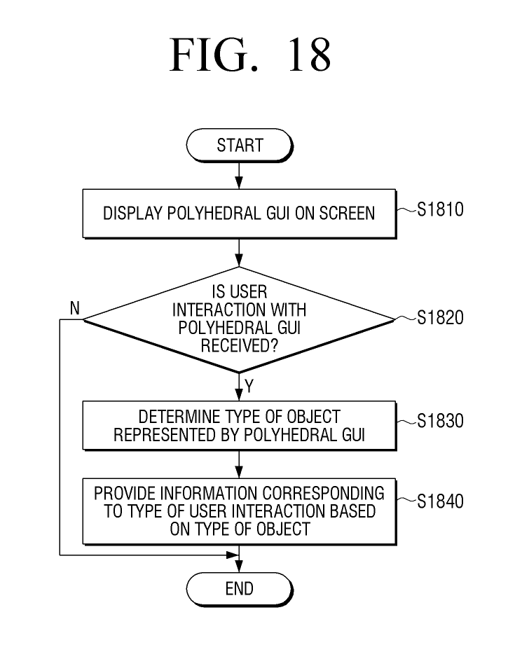

FIG. 18 is a view illustrating a UI screen providing method according to another exemplary embodiment.

According to the UI screen providing method illustrated in FIG. 18, a screen including a polyhedral GUI, for example, a cubic GUI, is displayed on a screen (operation S1810).

Subsequently, when a user interaction with the cubic GUI is received (operation S1820:Y), a type of the object represented by the cubic GUI is determined (operation S1830). For example, it may be determined whether the object represented by the cubic GUI is content provider information, service provider information, content information, user information, or the like.

Subsequently, information corresponding to the user interaction type is provided based on the determined object type (operation S1840). For example, when the object type is a content provider, content information (for example, a screen of a program being currently broadcast) currently provided by the content provider may be provided when the interaction type is a rotation interaction, and a content list provided by the content provider may be provided when the interaction type is a rubbing interaction with the cubic GUI. Further, when the object type is content, detailed information of the content, for example, genre information, may be provided when the interaction type is a rotation interaction, and associated content information related to the content may be provided when the interaction type is a rubbing interaction with one surface of the cubic GUI.

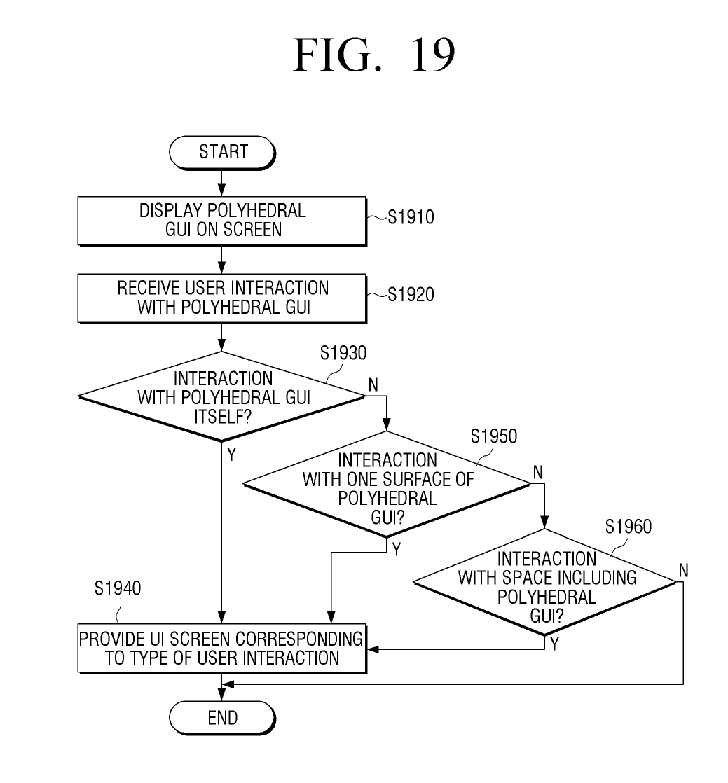

FIG. 19 is a view illustrating a UI screen providing method according to another exemplary embodiment.

According to the UI screen providing method illustrated in FIG. 19, a screen including a polyhedral GUI, for example, a cubic GUI, is displayed on a screen (operation S1910).

Subsequently, when a user interaction with the cubic GUI is received (operation S1920:Y), a type of the user interaction is determined.

When the user interaction is an interaction with the cubic GUI itself (operation S1930:Y), a UI screen corresponding to the user interaction type is provided (operation S1940). For example, information corresponding to a cubic surface exposed on a corresponding front surface may be provided by rotating the cubic GUI itself.

Further, when the user interaction is an interaction with one surface of the cubic GUI (operation S1950:Y), a UI screen corresponding to a type of the user interaction is provided (operation S1940). For example, corresponding information according to a scroll interaction with the one surface of the cubic GUI may be provided.

When the user interaction is an interaction with a space including the cubic GUI, that is, a cubic room (operation S1960:Y), a UI screen corresponding to a type of the user interaction is provided (operation S1940). For example, the cubic room is converted into another cubic room to be displayed or a display angle of the cubic room including a cubic GUI is changed to be displayed.

The UI according to above-described exemplary embodiments may be implemented in an application form in which software is directly used on an operating system (OS) by the user. Further, the application may be provided in an icon interface form on the screen of the display apparatus 100, although it is understood that one or more other exemplary embodiments are not limited thereto.

According to exemplary embodiments as described above, different operations and different information may be provided according to various user interaction types, and therefore, convenience of the user is improved.

While the above-described exemplary embodiments are in relation to a display apparatus 100 and 100′ including a display 110, it is understood that one or more other exemplary embodiments are not limited thereto. For example, one or more other exemplary embodiments are applicable to an image processing apparatus which does not include a display 110, such as a set-top box, an audio/video receiver, a Blu-Ray disc (BD) player, a digital versatile disc (DVD) player, a media streaming device, a gaming device, etc. In this case, the image processing apparatus may process, according to exemplary embodiments, user input interactions and images for display (including the above-described GUIs) on an external display device.

In this case, for example, the image processing apparatus may be configured similarly to the display apparatus 100 and 100′ described above, but without a display. For example, the image processing apparatus may include a user interface unit configured to receive a user interaction with a polyhedral GUI displayed on an external display apparatus. Here, the user interface unit may be embedded directly on the image processing apparatus (e.g., as keys on the image processing apparatus, a touch screen or panel on the image processing apparatus, a camera, a microphone, etc.), or may be an interface unit that receives the user interaction from an external device (e.g., the external display apparatus, a remote controller for the image processing apparatus, a remote controller for the image processing apparatus, a remote controller for the external display apparatus, etc.)

Additionally, the image processing apparatus may include a controller configured to output various information for display on the external display apparatus according to the received user interaction. For example, the controller may, in response to the received user interaction being an interaction for rotating the displayed polyhedral GUI, output for display different information according to a type of the received user interaction with the displayed polyhedral GUI. In this case, the controller may output for display first information (e.g., content information provided by a content provider represented by the displayed polyhedral GUI) in response to an interaction for rotating the displayed polyhedral GUI, may output for display second information (e.g., at least one of detailed information and associated information which have different levels) in response to a rubbing interaction with the displayed polyhedral GUI, and may output for display third information (e.g., additional content to that which is currently displayed) in response to a scroll interaction with the displayed polyhedral GUI.

Here, the interaction for rotating could be an interaction for rotating a single polyhedral GUI or an interaction for rotating a group polyhedral GUI. Additionally, in response to the rubbing interaction, the controller may output the at least one of detailed information and associated information with a particular level according to at least one of a rubbing strength and a rubbing time of the rubbing interaction.

Moreover, similar to the exemplary embodiment described above with reference to FIGS. 10A and 10B, the controller of the image processing apparatus could be configured to output for display a plurality of panel GUIs having a form in which the displayed polyhedral GUI is sliced according to the received user interaction. Similarly, the controller of the image processing apparatus could output for display advertising information in various ways as described above with reference to FIGS. 15A and 15B. As the operations and configurations of the image processing apparatus are similar to those described above with reference to the display apparatus 100 and 100′, a detailed description is omitted herein for sake of brevity.

The above-described control methods of according to the above-described various exemplary embodiments may be implemented with a computer-executable program code, recorded in various non-transitory computer-recordable media, and provided to servers or apparatuses to be executed by a processor.

For example, the non-transitory computer-recordable medium, in which a program for performing a method of generating a UI screen displaying different types of information according to a user interaction type is stored, may be provided.

The non-transitory computer-recordable medium is not a medium configured to temporarily store data such as a register, a cache, or a memory but an apparatus-readable medium configured to semi-permanently store data. Specifically, the above-described applications or programs may be stored and provided in the non-transitory computer-recordable medium such as a compact disc (CD), a digital versatile disc (DVD), a hard disk, a Blu-ray disc, a universal serial bus (USB), a memory card, or a read only memory (ROM). Moreover, it is understood that in exemplary embodiments, one or more components of the above-described apparatuses can include circuitry, a processor, a microprocessor, etc., and may execute a computer program stored in a computer-readable medium.

The foregoing exemplary embodiments and advantages are merely exemplary and are not to be construed as limiting the present inventive concept. The present teaching can be readily applied to other types of apparatuses. Also, the description of exemplary embodiments is intended to be illustrative, and not to limit the scope of the claims, and many alternatives, modifications, and variations will be apparent to those skilled in the art.

What is claimed is:

1. A display apparatus comprising:
a display configured to display a polyhedral graphic user interface (GUI) on a screen;
a user interface unit configured to receive a user interaction with the displayed polyhedral GUI; and
a controller configured to, in response to the received user interaction being an interaction for rotating the displayed polyhedral GUI, control to display content information by rotating the displayed polyhedral GUI and rotating other polyhedral GUIs determined to be related to the displayed polyhedral GUI.

2. The display apparatus as claimed in claim 1, wherein the content information is at least one of detailed information of content and associated information of content.

3. The display apparatus as claimed in claim 1, wherein the controller is configured to, in response to the received user interaction being the interaction for rotating the displayed polyhedral GUI, control to display the content information by simultaneously rotating, with the displayed polyhedral GUI, the other polyhedral GUIs determined to be related to the displayed polyhedral GUI.

4. A display apparatus comprising:
a display configured to display a polyhedral graphic user interface (GUI) on a screen;
a user interface unit configured to receive a user interaction with the displayed polyhedral GUI; and
a controller configured to control to display different information according to a type of the received user interaction with the displayed polyhedral GUI.

5. The display apparatus as claimed in claim 4, wherein the received user interaction is at least one of an interaction for rotating the displayed polyhedral GUI, a rubbing interaction with the displayed polyhedral GUI, and a scroll interaction with the displayed polyhedral GUI.

6. The display apparatus as claimed in claim 5, wherein the user interface unit is configured to receive either of an interaction for rotating a single polyhedral GUI and an interaction for rotating a group polyhedral GUI.

7. The display apparatus as claimed in claim 5, wherein in response to the received user interaction being the rubbing interaction with a surface of the displayed polyhedral GUI, the controller controls to display at least one of detailed information and associated information which have different levels according to at least one of a rubbing strength and a rubbing time of the rubbing interaction.

8. The display apparatus as claimed in claim 5, wherein in response to the received user interaction being the interaction for rotating when a first surface of the displayed polyhedral GUI including information on a content provider is displayed, the controller controls to rotate the displayed polyhedral GUI such that a second surface of the polyhedral GUI including content information provided by the content provider is displayed.

9. The display apparatus as claimed in claim 4, wherein:
the polyhedral GUI is displayed in a floating form in a three-dimensional (3D) space formed by three walls along an X-axis of the screen; and
the user input unit is configured to receive a peeping interaction within the 3D space.

10. The display apparatus as claimed in claim 4, wherein the controller is configured to control to display detailed information of content information on a plurality of panel GUIs having a form in which the displayed polyhedral GUI is sliced according to the received user interaction.

11. The display apparatus as claimed in claim 4, wherein in response to the received user interaction being a selection of advertising information displayed on a surface of the displayed polyhedral GUI, the controller is configured to control to display the advertisement information on at least some of all polyhedral GUIs displayed on the screen.

12. The display apparatus as claimed in claim 11, wherein, when the advertisement information displayed on the surface of the displayed polyhedral GUI is a preset image, the controller controls to display the preset image on the at least some of all the polyhedral GUIs separately or to magnify the preset image to one image and display the one image on the at least some of all the polyhedral GUIs.

13. The display apparatus as claimed in claim 4, wherein the controller is configured to control to provide a first type of information in response to a first interaction type according to the displayed polyhedral GUI representing a first type of content, and is configured to control to provide a second type of information in response to a second interaction type according to the displayed polyhedral GUI representing a second type of content.

14. A method of providing a user interface (UI) screen on a display apparatus, the method comprising:
displaying a polyhedral graphic user interface (GUI) on a screen;
receiving a user interaction with the displayed polyhedral GUI; and
displaying, in response to the received user interaction being an interaction for rotating the displayed polyhedral GUI, content information by rotating the displayed polyhedral GUI and rotating other polyhedral GUIs determined to be related to the displayed polyhedral GUI.

15. The method as claimed in claim 14, wherein the content information is at least one of detailed information of content and associated information of content.

16. The method as claimed in claim 14, wherein the displaying comprises displaying, in response to the received user interaction being the interaction for rotating the displayed polyhedral GUI, the content information by simultaneously rotating, with the displayed polyhedral GUI, the other polyhedral GUIs determined to be related to the displayed polyhedral GUI.

17. The method as claimed in claim 14, wherein the displaying comprises displaying, in response to the received user interaction being the interaction for rotating the displayed polyhedral GUI, the content information by sequentially rotating the other polyhedral GUIs determined to be related to the displayed polyhedral GUI.

18. A method of providing a user interface (UI) screen on a display apparatus, the method comprising:
displaying a polyhedral graphic user interface (GUI) on a screen;
receiving a user interaction with the displayed polyhedral GUI; and
displaying different information according to a type of the received interaction with the displayed polyhedral GUI.

19. The method as claimed in claim 18, wherein the received user interaction is at least one of an interaction for rotating the displayed polyhedral GUI, a rubbing interaction with the displayed polyhedral GUI, and a scroll interaction with the displayed polyhedral GUI.

20. The method as claimed in claim 19, wherein the interaction for rotating the polyhedral GUI includes at least one of an interaction for rotating a single polyhedral GUI, and an interaction for rotating a group polyhedral GUI.

21. The method as claimed in claim 19, wherein the displaying the different information comprises, in response to the received user interaction being the rubbing interaction with a surface of the displayed polyhedral GUI, displaying at least one of detailed information and associated information which have different levels according to at least one of a rubbing strength and a rubbing time of the rubbing interaction.

22. The method as claimed in claim 18, wherein:
the polyhedral GUI is displayed in a floating form in a three-dimensional (3D) space formed by three walls along an X-axis of the screen, and
the received user interaction includes a peeping interaction within the 3D space.

23. The method as claimed in claim 18, wherein the displaying the different information comprises displaying detailed information of content information on a plurality of panel GUIs in a form in which the displayed polyhedral GUI is sliced according to the received user interaction.

24. The method as claimed in claim 18, further comprising, in response to the received user interaction being a selection of advertising information displayed on a surface of the displayed polyhedral GUI, displaying the advertisement information on at least some of all polyhedral GUIs displayed on the screen.

25. The method as claimed in claim 24, wherein, when the advertisement information displayed on the surface of the displayed polyhedral GUI is a preset image, the displaying the advertisement information comprises displaying the preset image on the at least some of all the polyhedral GUIs separately or magnifying the preset image to one image and displaying the one image on the at least some of all the polyhedral GUIs.

26. The method as claimed in claim 18, further comprising displaying a GUI comprising a connecting area and a plurality of hexahedral 3D spaces around the connecting area and connected to each other through the connecting area,
wherein the plurality of hexahedral 3D spaces respectively correspond to a plurality of different categories, and
wherein the displaying the polyhedral GUI comprises, in response to a selection of a hexahedral 3D space among the plurality of hexahedral 3D spaces, displaying a plurality of polyhedral GUIs, including the polyhedral GUI, corresponding to a category of the selected hexahedral 3D space.

27. The method as claimed in claim 26, wherein the displaying the GUI comprising the connecting area and the plurality of hexahedral 3D spaces comprises rotating the GUI comprising the connecting area and the plurality of hexahedral 3D spaces in response to a received user interaction for rotating the GUI.

28. The method as claimed in claim 18, wherein the received user interaction is received via a remote controller as a touch command to the remote controller, a motion command of the remote controller, or a voice command to the remote controller.

29. An image processing apparatus comprising:
a user interface unit configured to receive a user interaction with a displayed polyhedral GUI; and
a controller configured to, in response to the received user interaction being an interaction for rotating the displayed polyhedral GUI, output for display different information according to a type of the received user interaction with the displayed polyhedral GUI.

30. The image processing apparatus as claimed in claim 29, wherein controller is configured to output for display:
first information on the displayed polyhedral GUI in response to the received user interaction being an interaction for rotating the displayed polyhedral GUI;
second information on the displayed polyhedral GUI in response to the received user interaction being a rubbing interaction with the displayed polyhedral GUI; and
third information on the displayed polyhedral GUI in response to the received user interaction being a scroll interaction with the displayed polyhedral GUI.

31. A non-transitory computer readable recording medium having recorded thereon a program executable by a computer for performing the method of claim 14.

32. A non-transitory computer readable recording medium having recorded thereon a program executable by a computer for performing the method of claim 18.
